(19) United States
(12) Patent Application Publication
(10) Pub. No.: US 2026/0196753 A1
(43) Pub. Date: Jul. 9, 2026

(54) CONNECTOR PLUG, CONNECTOR, AND ELECTRONIC DEVICE

(71) Applicant: HUAWEI TECHNOLOGIES CO., LTD., Shenzhen (CN)

(72) Inventors: Hongyu Zhao, Shanghai (CN); Tien Chieh SU, Shanghai (CN); Xiliang Shan, Shanghai (CN); Zhiyue Guo, Shanghai (CN); Tianhua Liu, Dongguan (CN)

(73) Assignee: HUAWEI TECHNOLOGIES CO., LTD., Shenzhen (CN)

(21) Appl. No.: 19/556,306

(22) Filed: Mar. 4, 2026

Related U.S. Application Data
(63) Continuation of application No. PCT/CN2025/085945, filed on Mar. 28, 2025.

(30) Foreign Application Priority Data
Jun. 17, 2024 (CN) 202410783205.5

(51) Int. Cl. H01R 12/71

(52) U.S. Cl. CPC H01R 12/716

(57) ABSTRACT

This disclosure presents a connector plug, a connector, and an electronic device. The connector plug includes a reinforcing member, a first body, and a plurality of first connection terminals. The reinforcing member is made of metal. The reinforcing member is embedded into the first body. The reinforcing member has at least one interruption hole. The interruption hole has an orthographic projection on the reinforcing member in a length direction of the reinforcing member. A ratio of a dimension of the orthographic projection in a width direction of the reinforcing member to a width of the reinforcing member is greater than or equal to 90%. The first connection terminal is fastened to the first body and is partially embedded into the first body. In this disclosure, the reinforcing member is made of metal and is embedded into the first body, to improve strength of the connector plug.

### CROSS-REFERENCE TO RELATED APPLICATIONS

This application is a continuation of International Application No. PCT/CN2025/085945, filed on Mar. 28, 2025, which claims priority to Chinese Patent Application No. 202410783205.5, filed on Jun. 17, 2024. The disclosures of the aforementioned applications are hereby incorporated by reference in their entirety.

### TECHNICAL FIELD

This disclosure relates to the field of electronic device technologies, and more specifically, to a connector plug, a connector, and an electronic device.

### BACKGROUND

Electronic products have become indispensable items in daily life of users. With rapid development of the electronic products, electronic devices have increasingly diversified functions and increasingly powerful performance. Implementation of various functions on an electronic device depends on information exchange between functional modules. Currently, the functional modules are usually connected through a board-to-board (BTB) connector, to save mounting space in the electronic device while simplifying a connection and assembly process and improving connection reliability.

With a sharp increase in a quantity of functional modules in the electronic device, a quantity of BTB connectors for connecting the functional modules also gradually increases. To mount sufficient BTB connectors in limited space of the electronic device, a size of the BTB connector needs to be small. In addition, to meet increasing requirements of the users for miniaturization and thinness of the electronic products, a stacking layout of an entire device is increasingly compact, and operational space for BTB assembly and snap-fit is increasingly limited.

However, a decrease in the size of the BTB connector may cause a decrease in overall strength of the BTB connector. Consequently, the BTB connector is prone to damage during assembly of the electronic device, leading to poor contact and the like. This severely affects a product yield rate of the electronic device. Therefore, how to ensure the strength of the BTB connector has become an urgent problem to be resolved.

### SUMMARY

This disclosure provides a connector plug, a connector, and an electronic device. The connector plug includes a reinforcing member and a first body. The reinforcing member is made of metal, and the reinforcing member is embedded into the first body, to improve strength of the connector plug.

According to a first aspect, this disclosure provides a connector plug, including a reinforcing member, a first body, and a plurality of first connection terminals. The reinforcing member is made of metal. The reinforcing member is embedded into the first body. The reinforcing member has at least one interruption hole. The interruption hole has an orthographic projection on the reinforcing member in a length direction of the reinforcing member. A ratio of a dimension of the orthographic projection in a width direction of the reinforcing member to a width of the reinforcing member is greater than or equal to 90%. The first connection terminal is fastened to the first body, and is partially embedded into the first body.

In this disclosure, the reinforcing member is embedded into the first body, so that overall structural strength of the first body can be improved, to improve structural strength of the connector plug. This helps improve stability of plugging/unplugging between the connector plug and a connector receptacle, to further optimize a product yield rate of an electronic device.

In this disclosure, the reinforcing member may be disposed on one side of the first body and at least partially embedded into the first body, so that the reinforcing member forms the bottom of the connector plug. Because the reinforcing member may be made of metal, the reinforcing member has sufficient strength, to provide strength support for the connector plug. In this way, two side surfaces of the reinforcing member that are exposed from the first body do not need to be covered with plastic, to implement thinning while ensuring overall structural strength of the connector plug.

In this disclosure, the reinforcing member may further have at least one interruption hole, to reduce a risk of warpage and deformation of the reinforcing member during oven processing, and improve overall structural strength and flatness of the reinforcing member. This helps improve stability of a connection between the reinforcing member and the first body.

In this disclosure, a ratio of a size of the interruption hole to a size of the reinforcing member is designed, to effectively eliminate stress, and effectively reduce a risk of warpage and deformation of the reinforcing member during oven processing.

In some embodiments, a part of the first body is embedded into the interruption hole.

In this example, a part of the first body is embedded into the interruption hole. In this way, the part of the first body that is embedded into the interruption hole and a part of the first body that is embedded into an accommodation hole jointly perform position limiting for the reinforcing member. This further improves a position-limiting capability of the first body for the reinforcing member, further improves strength of a connection between the first body and the reinforcing member, and helps improve structural strength of the connector plug.

In some embodiments, the reinforcing member has a plurality of accommodation holes. At least a part of the plurality of accommodation holes are arranged in the length direction of the reinforcing member. The interruption hole is located between two adjacent accommodation holes and is in communication with at least two accommodation holes.

In this example, the plurality of accommodation holes are arranged in the length direction of the reinforcing member, to improve strength of a connection between the reinforcing member and the first body at the positions in the length direction. This helps improve overall strength of a connection between the reinforcing member and the first body.

In this example, the interruption hole is in communication with at least two accommodation holes. In this way, a part of the reinforcing member that is between the at least two accommodation holes can be interrupted, to reduce a continuous length of a partial structure of the reinforcing member that is between a plurality of accommodation holes. This can reduce a risk of warpage and deformation of the reinforcing member during manufacturing, and specifically, can reduce a risk of warpage and deformation of the reinforcing member during oven processing, to improve overall structural strength and flatness of the reinforcing member. This helps improve stability of a connection between the reinforcing member and the first body.

The reinforcing member may include a primary connection beam and a plurality of secondary connection beams. The primary connection beam is located between two groups of accommodation holes. The secondary connection beam is connected to two sides of the primary connection beam that face away from each other, and the secondary connection beam is located between two adjacent accommodation holes in one group of accommodation holes.

In some embodiments, a part of the first body is embedded into the accommodation hole.

In this example, the reinforcing member is embedded into the first body, and the first body is also partially embedded into the accommodation hole of the reinforcing member, so that the reinforcing member and the first body are nested, and a part of the first body that is located at an outer periphery of the reinforcing member and the part of the first body that is located in the accommodation hole jointly perform position limiting and fastening for the reinforcing member. This improves strength of a connection between the reinforcing member and the first body, and further improves overall structural strength of the connector plug.

In some embodiments, the plurality of accommodation holes include two groups of accommodation holes. Each group of accommodation holes includes a plurality of accommodation holes arranged in the length direction of the reinforcing member. The two groups of accommodation holes are arranged in the width direction of the reinforcing member. The interruption hole is in communication with at least one accommodation hole in one group of accommodation holes and at least one accommodation hole in the other group of accommodation holes.

In this example, two groups of accommodation holes arranged in parallel are provided. This helps further improve strength of a connection between the first body and the reinforcing member, to improve overall structural strength of the connector plug.

In this example, the primary connection beam is interrupted by the interruption hole, to reduce a continuous length of the primary connection beam, and reduce a risk of warpage and deformation of the reinforcing member during oven processing.

In some embodiments, the interruption hole may be in communication with at least two adjacent accommodation holes in one group of accommodation holes and at least two adjacent accommodation holes in the other group of accommodation holes. In other words, the interruption hole is formed by interrupting the primary connection beam and at least two secondary connection beams on two sides of the primary connection beam.

In some other embodiments, the interruption hole may be in communication with one accommodation hole in one group of accommodation holes and one accommodation hole in the other group of accommodation holes. In other words, the interruption hole is formed by interrupting only the primary connection beam.

In still other embodiments, there may be at least two interruption holes, and each interruption hole may be in communication with one accommodation hole in one group of accommodation holes and one accommodation hole in the other group of accommodation holes. In other words, at least two interruption holes may be formed by interrupting only the primary connection beam, with at least two areas on the primary connection beam being interrupted.

The interruption hole may be located in a center area of the reinforcing member in the length direction. In other words, the interruption hole is formed by interrupting the center area close to the primary connection beam in the length direction.

In this example, the interruption hole is designed in the middle. This not only helps ensure strength consistency of structures of the reinforcing member on two sides of the interruption hole, but also helps prevent a continuous length of a partial structure of the primary connection beam in the reinforcing member from being excessively long, to help further reduce a risk of warpage and deformation of the reinforcing member during oven processing.

In some embodiments, the first body includes two cantilevers and a connection arm. The connection arm is connected between the two cantilevers. One cantilever corresponds to one group of accommodation holes. A part of the cantilever is embedded into the corresponding group of accommodation holes. The connection arm is embedded into the interruption hole.

In this example, the connection arm embedded into the interruption hole may be integrated with the two cantilevers, to improve a position-limiting capability of the connection arm for the reinforcing member, and further improve strength of a connection between the reinforcing member and the first body. The reinforcing member has two groups of accommodation holes, and each group of accommodation holes can correspond to one cantilever of the first body, so that strength of a connection between the reinforcing member and the two cantilevers can be improved through the two groups of accommodation holes. This improves strength of a connection between the reinforcing member and the first body, and further improves overall stability of the connector plug.

In some embodiments, the reinforcing member includes a first part and a second part connected to each other. The first part of the reinforcing member is mounted on one side of the first body. Relative to the first part of the reinforcing member, the second part of the reinforcing member is bent in a direction of being embedded into the first body.

In this example, relative to the first part of the reinforcing member, the second part of the reinforcing member may be disposed to be bent in the direction of being embedded into the first body, to improve strength of a connection between the reinforcing member and the first body, and further improve structural strength of the connector plug.

The reinforcing member may cover at least a part of fitting space that is located on a first side of the first body.

The first part of the reinforcing member may be embedded into a surface on the first side of the first body, to further improve strength of a connection between the reinforcing member and the first body, and improve structural strength of the connector plug.

A surface, facing away from a second side of the first body, of the reinforcing member may be flush with the surface on the first side of the first body, to improve flatness of the surface of the connector plug on the first side of the first body.

In some embodiments, a part of the accommodation hole is located in the first part of the reinforcing member.

In some embodiments, the other part of the accommodation hole is located in the second part of the reinforcing member.

In this example, a part of the accommodation hole is located in the first part of the reinforcing member, and the other part of the accommodation hole is located in the second part of the reinforcing member. In this way, the part of the first body that is embedded into the accommodation hole can perform position limiting for both the first part and the second part of the reinforcing member, to increase a position-limiting range for the reinforcing member in a thickness direction of the first body. This helps improve strength of a connection between the first body and the reinforcing member, to improve structural strength of the connector plug.

In some embodiments, the connector plug further includes an insulation layer, and the insulation layer covers at least a partial surface of the reinforcing member.

In this example, the insulation layer covers at least a partial surface of the reinforcing member, to prevent the first connection terminal from deviating due to flow of an injection molding material and getting in contact with the reinforcing member during formation of the first body through injection molding. The insulation layer prevents an open circuit caused by contact between the first connection terminal and the reinforcing member. In addition, the insulation layer may further prevent a short circuit in the following case: A process error of the first connection terminal causes an excessively small creepage distance between the first connection terminal and the reinforcing member; or a process defect, for example, a burr on an outer surface of the first connection terminal, causes contact between the first connection terminal and the reinforcing member.

The insulation layer may cover an area, close to the first connection terminal, of the reinforcing member. For example, the insulation layer may cover an inner side wall of the accommodation hole, and/or the insulation layer may cover an area, directly facing the first connection terminal, of the reinforcing member.

The insulation layer may alternatively cover the surfaces of the reinforcing member, to further improve insulation performance of the reinforcing member and reduce a risk of a short circuit.

The insulation layer may be made of an insulation material such as insulation spray paint or insulation plastic. A thickness range of the insulation layer may be within a range of 0.08 mm to 0.12 mm, so that the insulation layer can provide good insulation effect for the reinforcing member, without excessively increasing a thickness of the reinforcing member.

In some embodiments, the first body has the first side and the second side that are arranged facing away from each other, and the reinforcing member is embedded into the first side of the first body. The first connection terminal is sleeved on an outer surface on the second side of the first body, and is partially embedded into the first body.

In this example, the first connection terminal is partially embedded into the first body, to further improve strength of a connection between the first connection terminal and the first body, and improve stability of mounting of the first connection terminal. This helps improve stability of the first connection terminal during plugging/unplugging between the connector plug and the connector receptacle.

In some embodiments, the first connection terminal includes a first part and a second part connected to each other, and the first part of the first connection terminal extends out of the first body. The second part of the first connection terminal is of a U-shaped structure, is sleeved on the outer surface on the second side of the first body, and is partially embedded into the first body. An opening of the U-shaped structure of the second part of the first connection terminal faces the reinforcing member.

In this example, the first part of the first connection terminal extends out of the first body, so that a first end of the first connection terminal can extend out of the first body. This enables the first end of the first connection terminal to connect to an external circuit. The first connection terminal is sleeved on the cantilever, so that the U-shaped structure of the second part of the first connection terminal can match the cantilever, to implement structural adaptation between the first connection terminal and the cantilever. This helps improve strength of a connection between the first connection terminal and the first body.

In this example, the opening of the U-shaped structure of the second part of the first connection terminal faces the reinforcing member, so that the first connection terminal is designed as a reverse terminal compared with a first connection terminal in the conventional technology. This can avoid interference between the second part of the first connection terminal and the reinforcing member in a thickness direction of the connector plug, to facilitate a thinning design of the connector plug.

In some embodiments, the first connection terminal is not in contact with the reinforcing member.

In this example, the first connection terminal is disposed to be in no contact with the reinforcing member, to reduce a risk of a short circuit.

In some embodiments, the first connection terminal includes the first end and a second end that are arranged opposite to each other, and the first end of the first connection terminal extends out of the first body, to connect to an external circuit. At least a part of the second end of the first connection terminal is embedded into the first body.

In this example, the second end of the first connection terminal is at least partially embedded into the first body, to further improve strength of a connection between the first connection terminal and the first body, and improve stability of mounting of the first connection terminal. This helps improve stability of the first connection terminal during plugging/unplugging between the connector plug and the connector receptacle.

In some embodiments, the reinforcing member has a plurality of accommodation holes, and one accommodation hole accommodates at least a part of second ends of at least two first connection terminals.

In this example, the accommodation hole of the reinforcing member is designed to be large, so that one accommodation hole can accommodate at least a part of second ends of at least two first connection terminals. This helps reduce a quantity of accommodation holes provided on the reinforcing member, to increase a width of a part of the reinforcing member between two adjacent accommodation holes, and improve structural strength of the part of the reinforcing member between the two adjacent accommodation holes. This helps improve overall structural strength of the reinforcing member.

In some embodiments, at least two first connection terminals that are partially accommodated in one accommodation hole are arranged in the length direction of the reinforcing member. In the length direction of the reinforcing member, a side, close to an inner wall of the accommodation hole, of the second end of the first connection terminal is provided with a clearance groove.

In this example, the clearance groove is provided to increase a creepage distance between the second end of the first connection terminal and the reinforcing member, to increase a safety spacing between the first connection terminal and the reinforcing member, and avoid a short circuit between the first connection terminal and the reinforcing member. In addition, because one accommodation hole can accommodate at least two first connection terminals, only one clearance groove needs to be provided on a side, close to an inner wall of the reinforcing member, of the second end of the first connection terminal, without a need to provide clearance grooves on both sides of the second end of the first connection terminal. In this way, a dimension of the second end of the first connection terminal in the length direction of the reinforcing member can be designed to be larger, to reduce difficulty in preparing the first connection terminal. In addition, because only one clearance groove needs to be provided on the side, close to the inner wall of the reinforcing member, of the second end of the first connection terminal, a size of the clearance groove may be designed to be large, to further increase a creepage distance between the second end of the first connection terminal and the reinforcing member, further increase a safety spacing between the first connection terminal and the reinforcing member, and further avoid a short circuit between the first connection terminal and the reinforcing member.

In some embodiments, the part of the first body that is embedded into the accommodation hole has a positioning groove, and an opening of the positioning groove faces away from the first connection terminal. The second end of the first connection terminal is embedded into the first body and is exposed in the positioning groove. An end face of the second end of the first connection terminal is flush with a bottom wall of the positioning groove.

In this example, during formation of the first body through injection molding, a fastening structure may be designed, by using an injection mold, to abut against the end face of the second end of the first connection terminal, to ensure stability of the first connection terminal during formation of the first body through injection molding. This prevents the first connection terminal from moving with flow of an injection molding material, to prevent contact or an excessively small creepage distance between the first connection terminal and the reinforcing member. After the first body is formed through injection molding, the positioning groove is formed at a position at which the fastening structure abuts against the end face of the second end of the first connection terminal.

In this example, the end face of the first connection terminal that is exposed in the positioning groove may be flush with the bottom wall of the positioning groove, so that the second end of the first connection terminal can be better wrapped by the first body. This helps improve strength of a connection between the first connection terminal and the first body.

In some embodiments, the first body includes two cantilevers and two connection ends, and the two cantilevers are arranged opposite to each other. The two connection ends are respectively connected to two opposite ends of the cantilever, and the connection end is connected between the two cantilevers. The two cantilevers and the two connection ends enclose the fitting space, and the reinforcing member covers at least a part of one side of the fitting space.

In this example, the two cantilevers and the two connection ends enclose the fitting space. This helps reduce an overall thickness of a connector after the connector plug is plugged into the connector receptacle, to implement an overall thinning design of the connector.

In some embodiments, the connector plug further includes a first end hardware, and the first end hardware is sleeved on the connection end. The first end hardware includes a first part, a second part, and a third part. The first part of the first end hardware and the third part of the first end hardware are connected to two opposite ends of the second part of the first end hardware, and the first part of the first end hardware and the third part of the first end hardware protrude toward a same side of the second part of the first end hardware. The first part of the first end hardware, the second part of the first end hardware, and the third part of the first end hardware are continuously connected.

In this example, the first body may be formed through injection molding by using an injection mold in fitting with the first end hardware, the first connection terminal, and the reinforcing member, to improve strength of a connection between the first body and the first end hardware. In some other embodiments, the first end hardware may be sleeved on the connection end after the first body is formed through injection molding.

In this example, the first part, the second part, and the third part of the first end hardware are arranged in an enclosed manner to form a concave structure. This helps improve strength of a connection between the first end hardware and the first body.

In this example, the first end hardware may undergo a metal drawing process, so that the parts of the first end hardware are continuous without interruption. This can improve continuity of joints between the first part, the second part, and the third part of the first end hardware, and can also improve straightness of a straight-line structural area of the first end hardware, to improve structural strength and a guiding capability of the first end hardware.

The first end hardware may further include a fourth part. The fourth part of the first end hardware is connected to one end of the second part of the first end hardware, and is located between the first part of the first end hardware and the third part of the first end hardware.

In this example, the second part and the fourth part of the first end hardware can clamp the connection end of the first body, to improve strength of a connection between the first end hardware and the first body.

According to a second aspect, this disclosure further provides a connector, including a connector receptacle and the connector plug according to any one of the foregoing examples. The connector plug fits with and is electrically connected to the connector receptacle.

In this example, the connector plug is designed, so that after the connector plug is plugged into the connector receptacle, an overall thickness of the connector is reduced, and the connector has good structural strength. This facilitates a thinning design of the connector.

In some embodiments, the connector receptacle includes a second body and a plurality of second connection terminals. The second body includes a first part and a second part. The first part of the second body has an accommodation cavity. The second part of the second body is protrudingly disposed on a bottom wall of the accommodation cavity. The second connection terminal is located in the accommodation cavity, and the second connection terminal is mounted between the first part of the second body and the second part of the second body. A first body of the connector plug is plugged into the accommodation cavity of the second body of the connector receptacle. A first connection terminal and the second connection terminal are in conductive contact in a one-to-one correspondence manner.

In this example, fitting space of the connector plug and the accommodation cavity of the connector receptacle are designed, so that the connector plug can snap-fit with the connector receptacle during plugging. This not only can improve stability of a connection between the connector plug and the connector receptacle, but also helps reduce an overall thickness of the connector after the connector plug is plugged into the connector receptacle, to facilitate a miniaturization design of the connector. In addition, a reinforcing member is designed, to improve structural strength after the connector plug is plugged into the connector receptacle, and further improve overall structural strength of the connector.

In some embodiments, a limiting slot is provided on a surface, facing the first part of the second body, of the second part of the second body. The second connection terminal includes a first part, a second part, and a third part that are sequentially connected. The first part of the second connection terminal is at least partially embedded into the first part of the second body. The second part of the second connection terminal is mounted to the bottom wall of the accommodation cavity. The third part of the second connection terminal is at least partially accommodated in the limiting slot. The third part of the second connection terminal is spaced away from a bottom wall of the limiting slot. The third part of the second connection terminal is configured to move away from or close to the first part of the second connection terminal after being subject to a force. The first connection terminal includes a first part and a second part connected to each other. The first part of the first connection terminal extends out of the first body. The second part of the first connection terminal is of a U-shaped structure and is sleeved on an outer surface of the first body. The second part of the first connection terminal snap-fits between the first part of the second connection terminal and the third part of the second connection terminal. In a direction from the second part of the second body to the first part of the second body, a minimum spacing between the third part of the second connection terminal and the first part of the second connection terminal is less than a maximum dimension of the first connection terminal.

In this example, a bottom wall of a third mounting slot and the bottom wall of the limiting slot can perform position limiting for the second connection terminal, so that the first part of the second body and the second part of the second body perform position limiting for the second connection terminal during mounting. This helps improve stability of mounting of the second connection terminal.

The first part of the second connection terminal is of a convex structure. Specifically, an opening of the first part of the second connection terminal faces the bottom wall of the accommodation cavity, one end of the first part of the second connection terminal is connected to the second part of the second connection terminal, and the other end of the first part of the second connection terminal is bent to a bottom side of the first part of the second body. In this way, the first part of the second connection terminal can snap-fit with the first part of the second body, to improve stability of mounting of the second connection terminal.

In some embodiments, the connector receptacle further includes a middle island hardware, the middle island hardware is mounted to two ends of the second part of the second body, and the middle island hardware includes two elastic arms. In a direction from the first part of the second body to the second part of the second body, the two elastic arms are arranged opposite to each other, and the two elastic arms are configured to clamp the first body.

In this example, the elastic arms are disposed, so that the middle island hardware can snap-fit with the first end hardware, to improve stability of a connection between the middle island hardware and the first end hardware, and further improve stability of a connection between the connector plug and the connector receptacle. A dimension of the first end hardware in a width direction of the first body is greater than a minimum spacing between the two elastic arms. Therefore, in the connector, the elastic arms can keep abutting against the first end hardware based on a deformation recovery force, to improve stability of snap-fit between the middle island hardware and the first end hardware.

In the connector, a deformation amount of the second connection terminal may be greater than or equal to 0.1 mm, so that the second connection terminal can have a sufficiently strong deformation recovery force, and the second connection terminal can stably snap-fit with the first connection terminal.

In the width direction of the first body, the first end hardware in the connector plug abuts against the two elastic arms of the middle island hardware in the connector receptacle, where the dimension of the first end hardware in the width direction of the first body is greater than the minimum spacing between the two elastic arms.

In this example, the elastic arms are disposed, so that the middle island hardware can snap-fit with the first end hardware, to improve stability of a connection between the middle island hardware and the first end hardware, and further improve stability of a connection between the connector plug and the connector receptacle. A dimension of the first end hardware in a width direction of the first body is greater than a minimum spacing between the two elastic arms. Therefore, in the connector, the elastic arms can keep abutting against the first end hardware based on a deformation recovery force, to improve stability of snap-fit between the middle island hardware and the first end hardware.

In the connector, a deformation amount of the elastic arms may be greater than or equal to 0.1 mm, so that the middle island hardware can have a sufficiently strong deformation recovery force, and the middle island hardware can stably snap-fit with the first end hardware.

In a length direction of the first body, the first end hardware abuts against a second end hardware.

In this example, both the first end hardware and the second end hardware undergo a metal drawing process, so that effect of fitting between the first end hardware and the second end hardware is good, and stability of a connection between the connector plug and the connector receptacle is improved. In addition, the first end hardware and the second end hardware may participate in transmission of a current. Compared with an electrical connection between the first connection terminal and the second connection terminal, abutting between the first end hardware and the second end hardware can implement transmission of a large current.

According to a third aspect, this disclosure further provides an electronic device, including a first circuit board, a second circuit board, and the connector according to any one of the foregoing examples. A connector plug is electrically connected to the first circuit board, and a connector receptacle is electrically connected to the second circuit board.

In this example, a miniaturization design of the connector is implemented, and sufficient strength of the connector is ensured, so that more connectors can be designed in the electronic device. This helps enrich functional modules of the electronic device.

### BRIEF DESCRIPTION OF DRAWINGS

FIG. 1 is a diagram of a structure of an electronic device in some embodiments according to an embodiment of this disclosure;

FIG. 2A is a diagram of a structure of a connector plug in an electronic device shown in FIG. 1 in the conventional technology;

FIG. 2B is a diagram of a structure of a connector receptacle in an electronic device shown in FIG. 1 in the conventional technology;

FIG. 3A is a diagram of connections of a connector in an electronic device shown in FIG. 1 in some embodiments;

FIG. 3B is a diagram of a structure of a connector shown in FIG. 3A that is cut along a line A-A in some embodiments;

FIG. 4 is a schematic exploded view of a partial structure of a connector shown in FIG. 3A in some embodiments;

FIG. 5A is a diagram of a structure of a connector plug in a connector shown in FIG. 3A in some embodiments;

FIG. 5B is a diagram of a structure of a connector plug shown in FIG. 5A that is cut along a line B-B in some embodiments;

FIG. 6 is an exploded view of a partial structure of a connector plug shown in FIG. 5A in some embodiments;

FIG. 7A is a diagram of a structure of a reinforcing member in a connector plug shown in FIG. 5A in some embodiments;

FIG. 7B is a diagram of a size of a projection of an interruption hole in a reinforcing member shown in FIG. 7A in some embodiments;

FIG. 7C is a diagram of a structure of a reinforcing member in a connector plug shown in FIG. 5A in some other embodiments;

FIG. 7D is a diagram of a structure of a reinforcing member in a connector plug shown in FIG. 5A in still some other embodiments;

FIG. 8 is a diagram of a structure of a first connection terminal in a connector plug shown in FIG. 5A in some embodiments;

FIG. 9A is a diagram of relative positions of a first connection terminal and a reinforcing member in a connector plug shown in FIG. 5A in some embodiments;

FIG. 9B is a diagram of a structure of a first connection terminal and a reinforcing member shown in FIG. 9A that are cut along a line C-C in some embodiments;

FIG. 10 is a diagram of a structure of a first connection terminal and a reinforcing member shown in FIG. 9A being mounted to a first body in some embodiments;

FIG. 11A is a diagram of a partial structure of a connector plug shown in FIG. 10 that is cut along a line D-D in some embodiments;

FIG. 11B is a diagram of a partial structure of a connector plug shown in FIG. 10 that is cut along a line E-E in some embodiments;

FIG. 12A is a diagram of a partial structure of a connector plug shown in FIG. 10 that is cut along a line F-F in some embodiments;

FIG. 12B is a diagram of a partial structure of a connector plug shown in FIG. 10 that is cut along a line G-G in some embodiments;

FIG. 13 is a diagram of a partial structure of a connector plug shown in FIG. 10 from another perspective;

FIG. 14 is a diagram of a structure of a first body in a partial structure of the connector plug shown in FIG. 10 in some embodiments;

FIG. 15A is a diagram of a structure of a first body shown in FIG. 14 that is cut along a line H-H in some embodiments;

FIG. 15B is a diagram of a structure of a first body shown in FIG. 14 that is cut along a line I-I in some embodiments;

FIG. 16A is a diagram of a structure of a first body shown in FIG. 14 that is cut along a line J-J in some embodiments;

FIG. 16B is a diagram of a structure of a first body shown in FIG. 14 that is cut along a line K-K in some embodiments;

FIG. 17A is a diagram of a structure of a first end hardware in a connector plug shown in FIG. 5A in some embodiments;

FIG. 17B is a diagram of a structure of a first end hardware shown in FIG. 17A from another perspective;

FIG. 18 is a diagram of a structure of a first end hardware shown in FIG. 17A being mounted to a first body shown in FIG. 10 in some embodiments;

FIG. 19A is a diagram of a partial structure of a connector plug shown in FIG. 18 that is cut along a line L-L in some embodiments;

FIG. 19B is a diagram of a partial structure of a connector plug shown in FIG. 18 that is cut along a line M-M in some embodiments;

FIG. 20 is a diagram of a structure of a reinforcing member in a connector plug shown in FIG. 5A in still some other embodiments;

FIG. 21A is a diagram of a structure of a connector receptacle in a connector shown in FIG. 3A in some embodiments;

FIG. 21B is a diagram of a structure of a connector receptacle shown in FIG. 21A from another perspective;

FIG. 22 is a diagram of a structure of a connector receptacle shown in FIG. 21A that is cut along a line N-N in some embodiments;

FIG. 23 is a schematic exploded view of a partial structure of a connector receptacle shown in FIG. 21A in some embodiments;

FIG. 24 is a diagram of a structure of a second body in a connector receptacle shown in FIG. 21A in some embodiments;

FIG. 25A is a diagram of a structure of a second body shown in FIG. 24 that is cut along a line O-O in some embodiments;

FIG. 25B is a diagram of a structure of a second body shown in FIG. 24 that is cut along a line P-P in some embodiments;

FIG. 26 is a diagram of a structure of a second connection terminal in a connector receptacle shown in FIG. 21A in some embodiments;

FIG. 27A is a diagram of a structure of a second connection terminal shown in FIG. 26 being mounted to a second body shown in FIG. 24 in some embodiments;

FIG. 27B is a diagram of a partial structure of a connector receptacle shown in FIG. 27A that is cut along a line Q-Q in some embodiments;

FIG. 28A is a diagram of a structure of a second end hardware in a connector receptacle shown in FIG. 21A in some embodiments;

FIG. 28B is a diagram of a structure of a second end hardware shown in FIG. 28A from another perspective;

FIG. 29 is a diagram of a structure of a second end hardware shown in FIG. 28A being mounted to a second body shown in FIG. 27A in some embodiments;

FIG. 30A is a diagram of a structure of a middle island hardware in a connector receptacle shown in FIG. 21A in some embodiments;

FIG. 30B is a diagram of a structure of a middle island hardware shown in FIG. 30A from another perspective;

FIG. 31 is a diagram of a structure of a middle island hardware shown in FIG. 30A being mounted to a second body shown in FIG. 29 in some embodiments;

FIG. 32A is a diagram of a partial structure of a connector receptacle shown in FIG. 31 that is cut along a line R-R in some embodiments;

FIG. 32B is a diagram of a partial structure of a connector receptacle shown in FIG. 31 that is cut along a line S-S in some embodiments;

FIG. 33A is a diagram of a structure of a connector shown in FIG. 3A that is cut along a line T-T in some embodiments; and

FIG. 33B is a diagram of a structure of a connector shown in FIG. 3A that is cut along a line U-U in some embodiments.

### DESCRIPTION OF EMBODIMENTS

The following describes embodiments of this disclosure with reference to the accompanying drawings in embodiments of this disclosure.

In descriptions of embodiments of this disclosure, The terms “mount” and “connection” should be understood in a broad sense, unless otherwise clearly specified and limited. For example, the “connection” may be a detachable connection or a non-detachable connection, or may be a direct connection or a connection through an intermediate medium. “A plurality of” means at least two.

Orientation terms mentioned in embodiments of this disclosure, for example, “above”, “below”, “inner”, “outer”, “top”, “bottom”, and “side”, merely indicate directions with reference to the accompanying drawings. Therefore, the orientation terms are intended for better and more clearly describing and understanding embodiments of this disclosure, but not to indicate or imply that a specified apparatus or element needs to have a specific orientation or be constructed and operated in a specific orientation, and therefore cannot be construed as a limitation on embodiments of this disclosure.

Limitations on relative positional relationships, for example, being parallel, perpendicular, or aligned, are mentioned in embodiments of this disclosure. The limitations are defined based on a current technique level, and are not strict limitations. Deviation is allowed, and being approximately parallel, approximately perpendicular, approximately aligned, or the like is allowed. For example, that A is parallel to B means that A is parallel or approximately parallel to B, and an included angle between A and B may range from 0 degrees to 10 degrees. For example, that A is perpendicular to B means that A is perpendicular or approximately perpendicular to B, and an included angle between A and B may range from 80 degrees to 100 degrees.

In embodiments of this disclosure, the terms “first”, “second”, “third”, and “fourth” are merely intended for description, and shall not be understood as an indication or implication of relative importance or an implicit indication of a quantity of indicated technical features. Therefore, a feature limited by “first”, “second”, “third”, or “fourth” may explicitly or implicitly include one or more features.

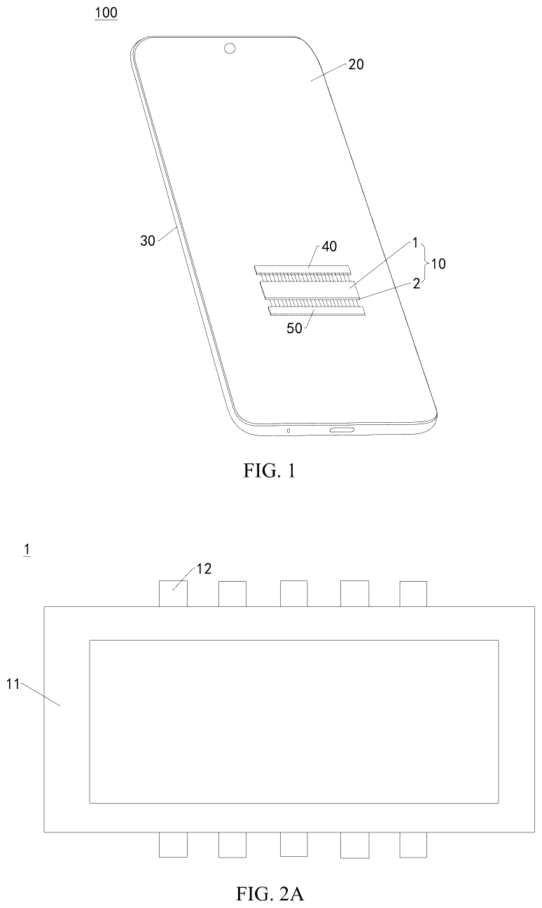

FIG. 1 is a diagram of a structure of an electronic device 100 in some embodiments according to an embodiment of this disclosure. The dashed lines in FIG. 1 indicate a structure of connections of a connector 10 in the electronic device 100.

In some embodiments, the electronic device 100 may be a device with a camera function, for example, a mobile phone, a tablet personal computer, a laptop computer, a smart screen, a personal digital assistant (PDA), a camera, a personal computer, a notebook computer, a vehicle-mounted device, a wearable device, augmented reality (AR) glasses, an AR helmet, virtual reality (VR) glasses, or a VR helmet. In the embodiment of FIG. 1, an example in which the electronic device 100 is a mobile phone is used for description. Certainly, another type of electronic device 100 may alternatively be of a similar structure. Details are not described below again.

It can be understood that FIG. 1 merely shows some components included in the electronic device 100 as an example. Actual shapes, actual sizes, actual positions, and actual structures of the components are not limited by FIG. 1. The electronic device 100 may alternatively include more or fewer components than those shown in FIG. 1.

In some embodiments, the electronic device 100 may include a connector 10, a screen 20, and a housing 30. The screen 20 is configured to display an image, a video, or the like. The screen 20 may include a transparent panel and a display. The transparent panel and the display are stacked and fastened. The transparent panel is mainly configured to protect the display and prevent dust from entering the display. A material of the transparent panel includes but is not limited to glass. The display may be a flexible display or a rigid display. For example, the display may be an organic light-emitting diode (OLED) display, an active-matrix organic light-emitting diode (AMOLED) display, a mini light-emitting diode display, a micro light-emitting diode display, a micro organic light-emitting diode display, a quantum dot light-emitting diode (QLED) display, or a liquid crystal display (LCD).

For example, the housing 30 is configured to protect an internal electronic component of the electronic device 100. The housing 30 may include a cover and a bezel. The cover is located on a side, away from the transparent panel, of the display, and is stacked with the transparent panel and the display. The bezel is fastened to the cover. For example, the bezel may be fastened to the cover by using adhesive. Alternatively, the bezel and the cover may be of an integrated structure. In other words, the bezel and the cover are of an integral structure. The bezel is located between the cover and the transparent panel. The transparent panel may be fastened to the bezel by using adhesive. The transparent panel, the cover, and the bezel enclose internal accommodation space of the electronic device 100. The display is accommodated in the internal accommodation space. The cover may be made of metal, plastic, glass, or the like. The cover may be a plate made of a single material, or may be of a plate structure made of a plurality of materials and formed by splicing a plurality of plates.

For example, the connector 10 may be mounted in the internal accommodation space. The connector 10 may include a connector plug 1 and a connector receptacle 2. The electronic device 100 may further include a first circuit board 40 and a second circuit board 50. The connector plug 1 fits with and is electrically connected to the connector receptacle 2. The connector plug 1 is electrically connected to the first circuit board 40. The connector receptacle 2 is electrically connected to the second circuit board 50. The connector 10 may be used to electrically connect a plurality of components in the electronic device 100. For example, the connector 10 may be used to electrically connect a module, for example, a camera, the screen 20, or a battery, to a main board. For example, the first circuit board 40 may be mounted to the camera, the second circuit board 50 may be mounted to the main board, and an electrical connection between the camera and the main board is implemented through the connector 10, to transmit an electrical signal between the camera and the main board.

In some other embodiments, the electronic device 100 may not include the screen 20, or the electronic device 100 may not include the housing 30, or the electronic device 100 may not include the screen 20 and the housing 30.

The following describes a structural design of a connector 10 in the conventional technology.

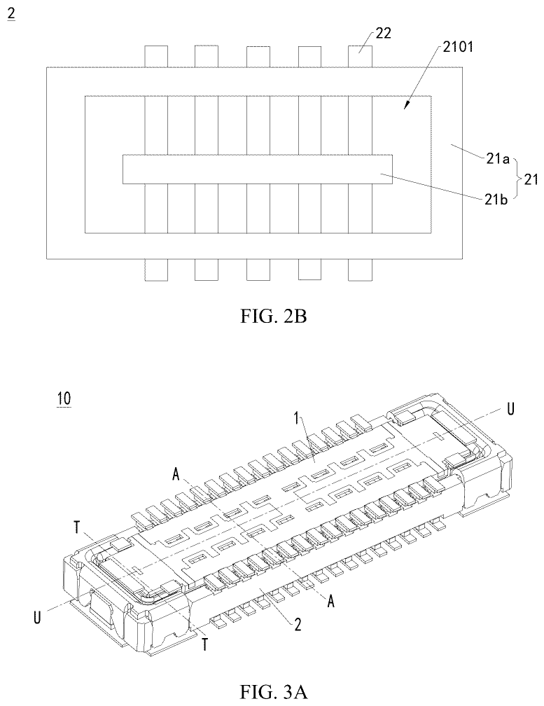

Refer to both FIG. 2A and FIG. 2B. FIG. 2A is a diagram of a structure of the connector plug 1 in the electronic device 100 shown in FIG. 1 in the conventional technology. FIG. 2B is a diagram of a structure of the connector receptacle 2 in the electronic device 100 shown in FIG. 1 in the conventional technology.

With rapid development of an electronic device 100, the electronic device 100 provides a user with increasingly diversified functions, for example, a photographing function, a video recording function, and a music playing function of a mobile phone. This means that a quantity of functional modules in the electronic device 100 increases. Implementation of various functions on the electronic device 100 depends on information exchange between functional modules. Currently, the functional modules are usually connected through a board-to-board (BTB) connector 10, to save mounting space in the electronic device 100 while simplifying a connection and assembly process and improving connection reliability.

In the conventional technology, the connector 10 includes a connector plug 1 and a connector receptacle 2 that may be connected through a signal. The connector plug 1 may include a first body 11 and a first connection terminal 12. A part of the first connection terminal 12 is hidden in the first body 11. The first body 11 is usually formed through injection molding on plastic, and is mainly configured to fasten the first connection terminal 12.

The connector receptacle 2 may include a second body 21 and a second connection terminal 22. The second body 21 may include a first part 21a and a second part 21b. The first part 21a of the second body 21 has an accommodation cavity 2101. The second part 21b of the second body 21 is protrudingly disposed on a bottom wall of the accommodation cavity 2101. The second part 21b of the second body 21 is also referred to as a middle island. The second body 21 is usually formed through injection molding on plastic, and may fasten each second connection terminal 22 while protecting the second connection terminal 22.

When the connector 10 is used to connect functional modules, the connector plug 1 in FIG. 2A may be connected to a circuit board of one functional module through a signal, and the connector receptacle 2 in FIG. 2B may be connected to a circuit board of the other functional module through a signal. In this way, the connector plug 1 is plugged into the connector receptacle 2, and the first connection terminal 12 of the connector plug 1 is electrically connected to the second connection terminal 22 of the connector receptacle 2, to implement signal transmission between the two functional modules. In addition, when the connector plug 1 of the connector 10 is being plugged into the connector receptacle 2, the second part 21b of the second body 21 may limit a depth at which the connector plug 1 is inserted into the first part 21a of the second body 21 while supporting the connector plug 1, so that the connector plug 1 is plugged in place, to implement effective contact between the first connection terminal 12 of the connector plug 1 and the second connection terminal 22 of the connector receptacle 2.

With a sharp increase in a quantity of functional modules in the electronic device 100, a quantity of connectors 10 for connecting the functional modules also gradually increases. To mount sufficient connectors 10 in limited space of the electronic device 100, a size of the connector 10 needs to be small. However, a decrease in the size of the connector 10 may cause a decrease in overall strength of the connector 10. Consequently, during assembly between the connector plug 1 and the connector receptacle 2 of the connector 10, the connection terminals in the connectors are likely to tilt, leading to poor contact and the like. This severely affects a product yield rate of the electronic device 100. Therefore, how to ensure the strength of the connector 10 has become an urgent problem to be resolved.

The following describes a structural design of a connector 10 provided in this disclosure.

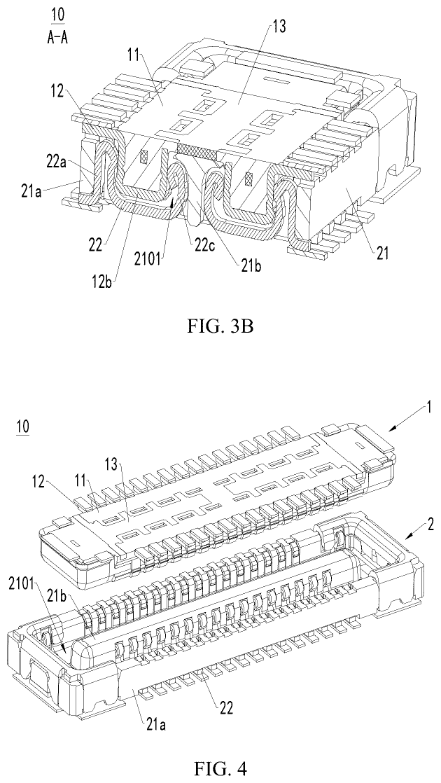

Refer to FIG. 3A to FIG. 4. FIG. 3A is a diagram of connections of the connector 10 in the electronic device 100 shown in FIG. 1 in some embodiments. FIG. 3B is a diagram of a structure of the connector 10 shown in FIG. 3A that is cut along a line A-A in some embodiments. FIG. 4 is a schematic exploded view of a partial structure of the connector 10 shown in FIG. 3A in some embodiments.

In some embodiments, the connector 10 may include a connector plug 1 and a connector receptacle 2. The connector plug 1 fits with and is electrically connected to the connector receptacle 2.

For example, the connector plug 1 may include a first body 11, a reinforcing member 13, and a plurality of first connection terminals 12. The first connection terminal 12 is fastened to the first body 11. The reinforcing member 13 is embedded into the first body 11, and strength of a material of the reinforcing member 13 is greater than strength of a material of the first body 11.

In this embodiment, the reinforcing member 13 is embedded into the first body 11, so that overall structural strength of the first body 11 can be improved, to improve structural strength of the connector plug 1. This helps improve stability of plugging/unplugging between the connector plug 1 and the connector receptacle 2, to further optimize a product yield rate of the electronic device 100.

The reinforcing member 13 may be made of metal. For example, the reinforcing member 13 may be made of alloy steel, steel, aluminum, or copper, but is not limited thereto.

The first body 11 may be made of plastic.

The reinforcing member 13 may be disposed on one side of the first body 11 and at least partially embedded into the first body 11, so that the reinforcing member 13 forms the bottom of the connector plug 1. Because the reinforcing member 13 may be made of metal, the reinforcing member 13 has sufficient strength, to provide strength support for the connector plug 1. In this way, two side surfaces of the reinforcing member 13 that are exposed from the first body 11 do not need to be covered with plastic, to implement thinning while ensuring overall structural strength of the connector plug 1.

For example, the connector receptacle 2 may include a second body 21 and a plurality of second connection terminals 22. The second body 21 may include a first part 21a and a second part 21b. The first part 21a of the second body 21 may have an accommodation cavity 2101. The second part 21b of the second body 21 is protrudingly disposed on a bottom wall of the accommodation cavity 2101. The second connection terminal 22 is fastened to the second body 21.

The connector plug 1 may be plugged into the connector receptacle 2, so that the connector plug 1 is inserted into the accommodation cavity 2101 of the connector receptacle 2, and the connector plug 1 fits with the connector receptacle 2. In addition, the first connection terminal 12 abuts against the second connection terminal 22, to implement an electrical connection between the first connection terminal 12 and the second connection terminal 22.

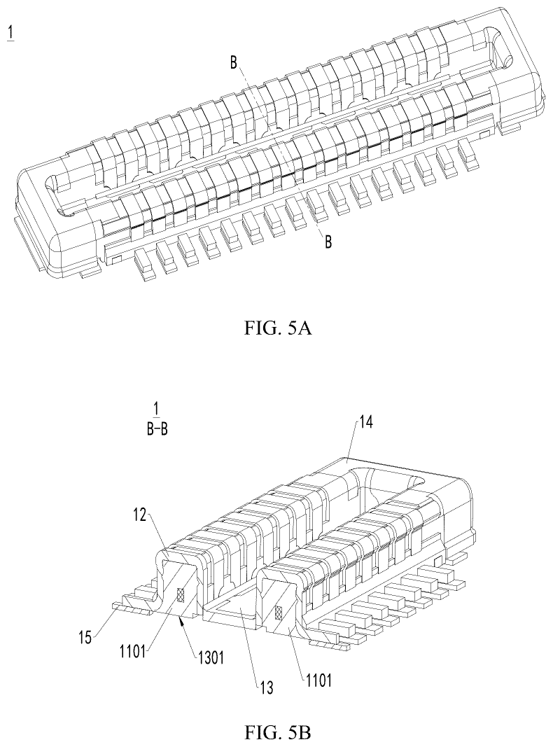

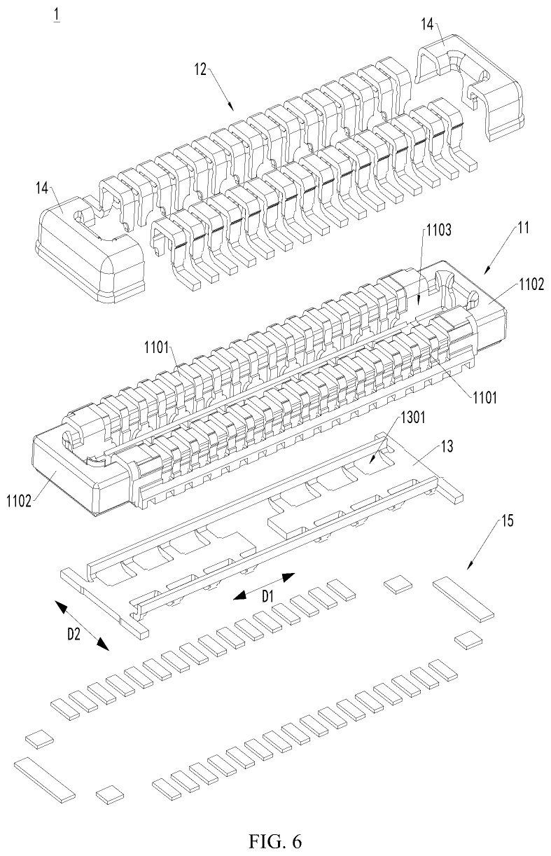

Refer to FIG. 5A to FIG. 6. FIG. 5A is a diagram of a structure of the connector plug 1 in the connector 10 shown in FIG. 3A in some embodiments. FIG. 5B is a diagram of a structure of the connector plug 1 shown in FIG. 5A that is cut along a line B-B in some embodiments. FIG. 6 is an exploded view of a partial structure of the connector plug 1 shown in FIG. 5A in some embodiments.

In some embodiments, the reinforcing member 13 may have a plurality of accommodation holes 1301, and a part of the first body 11 may be embedded into the accommodation hole 1301.

In this embodiment, the reinforcing member 13 is embedded into the first body 11, and the first body 11 is also partially embedded into the accommodation hole 1301 of the reinforcing member 13, so that the reinforcing member 13 and the first body 11 are nested, and a part of the first body 11 that is located at an outer periphery of the reinforcing member 13 and the part of the first body 11 that is located in the accommodation hole 1301 jointly perform position limiting and fastening for the reinforcing member 13. This improves strength of a connection between the reinforcing member 13 and the first body 11, and further improves overall structural strength of the connector plug 1.

For example, at least a part of the plurality of accommodation holes 1301 may be arranged in a length direction (refer to a direction D1 in FIG. 6) of the reinforcing member 13.

In this embodiment, the plurality of accommodation holes 1301 are arranged in the length direction of the reinforcing member 13, to improve strength of a connection between the reinforcing member 13 and the first body 11 at the positions in the length direction. This helps improve overall strength of a connection between the reinforcing member 13 and the first body 11.

The plurality of accommodation holes 1301 may include two groups of accommodation holes 1301. Each group of accommodation holes 1301 may include a plurality of accommodation holes 1301 arranged in the length direction of the reinforcing member 13. The two groups of accommodation holes 1301 are arranged in a width direction (refer to a direction D2 in FIG. 6) of the reinforcing member 13.

In this embodiment, two groups of accommodation holes 1301 arranged in parallel are provided. This helps further improve strength of a connection between the first body 11 and the reinforcing member 13, to improve overall structural strength of the connector plug 1.

In some embodiments, the first body 11 may include two cantilevers 1101 and two connection ends 1102. The two cantilevers 1101 may be arranged opposite to each other in the direction D2. The two connection ends 1102 may be respectively connected to two opposite ends of the cantilever 1101, and the connection end 1102 is connected between the two cantilevers 1101. In other words, the two connection ends 1102 may be arranged opposite to each other in the direction D1. The two cantilevers 1101 and the two connection ends 1102 may enclose fitting space 1103.

In this embodiment, the two cantilevers 1101 and the two connection ends 1102 enclose the fitting space 1103. This helps reduce an overall thickness of the connector 10 after the connector plug 1 is plugged into the connector receptacle 2, to implement an overall thinning design of the connector 10.

For example, one cantilever 1101 may correspond to one group of accommodation holes 1301, and a part of the cantilever 1101 is embedded into the corresponding group of accommodation holes 1301.

In this embodiment, the reinforcing member 13 has two groups of accommodation holes 1301, and each group of accommodation holes 1301 can correspond to one cantilever 1101 of the first body 11, so that strength of a connection between the reinforcing member 13 and the two cantilevers 1101 can be improved through the two groups of accommodation holes 1301. This improves strength of a connection between the reinforcing member 13 and the first body 11, and further improves overall stability of the connector plug 1.

In some other embodiments, the reinforcing member 13 may alternatively include only one group of accommodation holes 1301. The accommodation holes 1301 are arranged in the length direction of the reinforcing member 13.

In some embodiments, the first connection terminal 12 may be partially embedded into the first body 11, to improve strength of a connection between the first connection terminal 12 and the first body 11, and improve stability of the first connection terminal 12 during plugging/unplugging between the connector plug 1 and the connector receptacle 2. This helps increase a product yield rate of the electronic device 100.

The first connection terminal 12 may include two groups of terminals, and each group of terminals corresponds to one cantilever 1101.

In some embodiments, the connector plug 1 may further include a first end hardware 14 and a first pad 15.

For example, the first end hardware 14 may be disposed at two opposite ends of the first body 11, to improve structural strength of the first body 11. Specifically, the first end hardware 14 may be sleeved on the connection end 1102, to improve structural strength of the connection end 1102.

Two first end hardwares 14 may be located at two ends of the reinforcing member 13 and spaced away from the reinforcing member 13. In this embodiment, the reinforcing member 13 is embedded into the two cantilevers 1101 of the first body 11 to improve structural strength of the first body 11 at the two cantilevers 1101, and the two first end hardwares 14 are sleeved on the two connection ends 1102 of the first body 11 to improve structural strength of the first body 11 at the two connection ends 1102. In this way, overall structural strength of the first body 11 is improved through both the two first end hardwares 14 and the reinforcing member 13.

For example, the first pad 15 may be connected to the first connection terminal 12, to connect to an external circuit.

The first pad 15 may be further connected to the first end hardware 14, and a size of the first pad 15 connected to the first end hardware 14 may be greater than a size of the first pad 15 connected to the first connection terminal 12, so that the first pad 15 can connect to a larger external current through the first end hardware 14.

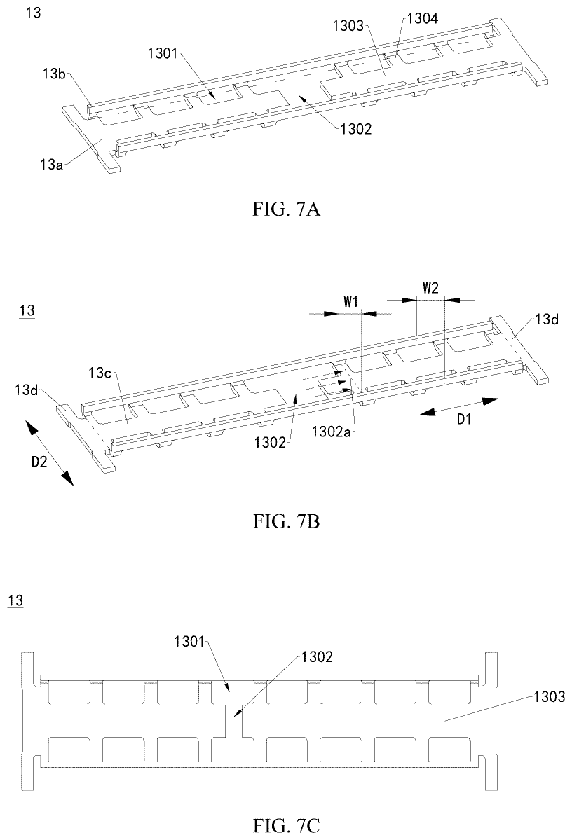

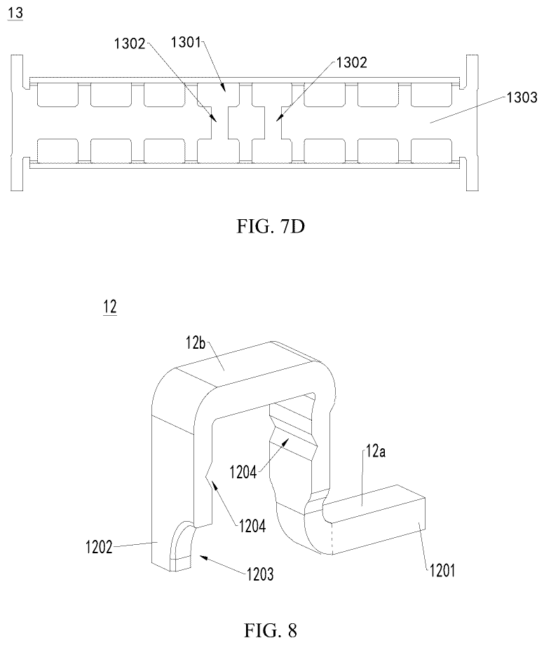

Refer to both FIG. 7A and FIG. 7B. FIG. 7A is a diagram of a structure of the reinforcing member 13 in the connector plug 1 shown in FIG. 5A in some embodiments. FIG. 7B is a diagram of a size of a projection of an interruption hole 1302 in the reinforcing member 13 shown in FIG. 7A in some embodiments.

In some embodiments, the reinforcing member 13 may further have at least one interruption hole 1302, to reduce a risk of warpage and deformation of the reinforcing member 13 during oven processing, and improve overall structural strength and flatness of the reinforcing member 13. This helps improve stability of a connection between the reinforcing member 13 and the first body 11.

For example, the interruption hole 1302 may have an orthographic projection 1302a on the reinforcing member 13 in the length direction (refer to a direction D1 in FIG. 7B) of the reinforcing member 13, and a ratio of a dimension (refer to W1 in FIG. 7B) of the orthographic projection 1302a in the width direction (refer to a direction D2 in FIG. 7B) of the reinforcing member 13 to a width (refer to W2 in FIG. 7B) of the reinforcing member 13 may be greater than or equal to 90%. In other words, W1/W2≥90%. For example, the ratio of W1/W2 may be but is not limited to 90%, 92%, 94%, 96%, or another value greater than or equal to 90%.

In this embodiment, a ratio of a size of the interruption hole 1302 to a size of the reinforcing member 13 is designed, to effectively eliminate stress, and effectively reduce a risk of warpage and deformation of the reinforcing member 13 during oven processing.

The orthographic projection 1302a is indicated by a dashed line in FIG. 7B. It can be understood that the orthographic projection 1302a may be at any position on the reinforcing member 13. FIG. 7B shows only one position as an example, but does not constitute a limitation a position of the orthographic projection 1302a.

The reinforcing member 13 may include a body part 13c and a pin 13d connected to two ends of the body part 13c. The interruption hole 1302 is provided on the body part 13c. The pin 13d is located at two ends of the body part 13c in the direction D1. The pin 13d may exceed the body part 13c in the direction D2, to connect to an external circuit. The width of the reinforcing member 13 is a dimension of the body part 13c in the direction D2.

For example, the interruption hole 1302 is located between two adjacent accommodation holes 1301 and is in communication with at least two accommodation holes 1301.

In this embodiment, the interruption hole 1302 is in communication with at least two accommodation holes 1301. In this way, a part of the reinforcing member 13 that is between the at least two accommodation holes 1301 can be interrupted, to reduce a continuous length of a partial structure of the reinforcing member 13 that is between a plurality of accommodation holes 1301. This can reduce a risk of warpage and deformation of the reinforcing member 13 during manufacturing, and specifically, can reduce a risk of warpage and deformation of the reinforcing member 13 during oven processing, to improve overall structural strength and flatness of the reinforcing member 13. This helps improve stability of a connection between the reinforcing member 13 and the first body 11.

For example, the reinforcing member 13 may include a primary connection beam 1303 and a plurality of secondary connection beams 1304. The primary connection beam 1303 is located between the two groups of accommodation holes 1301. The secondary connection beam 1304 is connected to two sides of the primary connection beam 1303 that face away from each other, and the secondary connection beam 1304 is located between two adjacent accommodation holes 1301 in one group of accommodation holes 1301.

The interruption hole 1302 may be in communication with at least one accommodation hole 1301 in one group of accommodation holes 1301 and at least one accommodation hole 1301 in the other group of accommodation holes 1301. In other words, the interruption hole 1302 is formed by interrupting at least the primary connection beam 1303.

In this embodiment, the primary connection beam 1303 is interrupted by the interruption hole 1302, to reduce a continuous length of the primary connection beam 1303, and reduce a risk of warpage and deformation of the reinforcing member 13 during oven processing.

Refer to FIG. 7A, FIG. 7C, and FIG. 7D. FIG. 7C is a diagram of a structure of the reinforcing member 13 in the connector plug 1 shown in FIG. 5A in some other embodiments. FIG. 7D is a diagram of a structure of the reinforcing member 13 in the connector plug 1 shown in FIG. 5A in still some other embodiments.

In some examples (refer to FIG. 7A), the interruption hole 1302 may be in communication with at least two adjacent accommodation holes 1301 in one group of accommodation holes and at least two adjacent accommodation holes 1301 in the other group of accommodation holes 1301. In other words, the interruption hole 1302 is formed by interrupting the primary connection beam 1303 and at least two secondary connection beams 1304 on two sides of the primary connection beam 1303.

In some other examples (refer to FIG. 7C), the interruption hole 1302 may be in communication with one accommodation hole 1301 in one group of accommodation holes 1301 and one accommodation hole 1301 in the other group of accommodation holes 1301. In other words, the interruption hole 1302 is formed by interrupting only the primary connection beam 1303.

In some other examples (refer to FIG. 7D), there may be at least two interruption holes 1302, and each interruption hole 1302 may be in communication with one accommodation hole 1301 in one group of accommodation holes 1301 and one accommodation hole 1301 in the other group of accommodation holes 1301. In other words, at least two interruption holes 1302 may be formed by interrupting only the primary connection beam 1303, with at least two areas on the primary connection beam 1303 being interrupted.

The interruption hole 1302 may be located in a center area of the reinforcing member 13 in the length direction. In other words, the interruption hole 1302 is formed by interrupting the center area close to the primary connection beam 1303 in the length direction.

In this embodiment, the interruption hole 1302 is designed in the middle. This not only helps ensure strength consistency of structures of the reinforcing member 13 on two sides of the interruption hole 1302, but also helps prevent a continuous length of a partial structure of the primary connection beam 1303 in the reinforcing member 13 from being excessively long, to help further reduce a risk of warpage and deformation of the reinforcing member 13 during oven processing.

In some other embodiments, the reinforcing member 13 may not be provided with the accommodation hole 1301, and is provided only with the interruption hole 1302; or the reinforcing member 13 includes the accommodation hole 1301, but the interruption hole 1302 is not in communication with the accommodation hole 1301.

Still refer to FIG. 7A and FIG. 7B. In some embodiments, the reinforcing member 13 may include a first part 13a and a second part 13b connected to each other, and the second part 13b of the reinforcing member 13 may be bent relative to the first part 13a of the reinforcing member 13. The second part 13b of the reinforcing member 13 may be connected to two sides of the first part 13a of the reinforcing member 13.

A part of the accommodation hole 1301 may be located in the first part 13a of the reinforcing member 13, and the other part of the accommodation hole 1301 may be located in the second part 13b of the reinforcing member 13. In some other embodiments, the accommodation hole 1301 may alternatively be located only in the first part 13a of the reinforcing member 13.

When the reinforcing member 13 includes the flat first part 13a and the second part 13b that is bent relative to the first part 13a, a ratio of the dimension of the orthographic projection 1302a of the interruption hole 1302 in the width direction of the reinforcing member 13 to a width of the first part 13 a of the reinforcing member 13 may be greater than or equal to 90%.

In some embodiments, a thickness of the reinforcing member 13 is less than or equal to 0.11 mm. For example, the thickness of the reinforcing member 13 may be 0.11 mm, 0.1 mm, 0.09 mm, 0.08 mm, 0.07 mm, or 0.06 mm. Therefore, in comparison with a conventional connector plug 1, the reinforcing member 13 can help reduce a height of the connector plug 1 while improving strength of the connector plug 1, to improve product competitiveness in terms of thinness. In addition, for example, the thickness of the reinforcing member 13 is 0.06 mm and the reinforcing member 13 is made of steel. Experiments show that, in comparison with the conventional connector plug 1, side push strength of the connector plug 1 is improved by 35.7%, and torsion strength is improved by 18.5%. It can be understood that, after a plug and a receiver of a conventional BTB connector 10 are assembled, middle plastic of the connector plug 1 and middle island plastic of the connector receptacle 2 are in a stop position. Therefore, a thickness of the middle plastic of the connector plug 1 affects a height of the connector 10. Therefore, reducing a height of the connector plug 1 while ensuring strength of the connector plug 1 can also help reduce a height of the connector 10 while ensuring strength of the BTB connector 10.

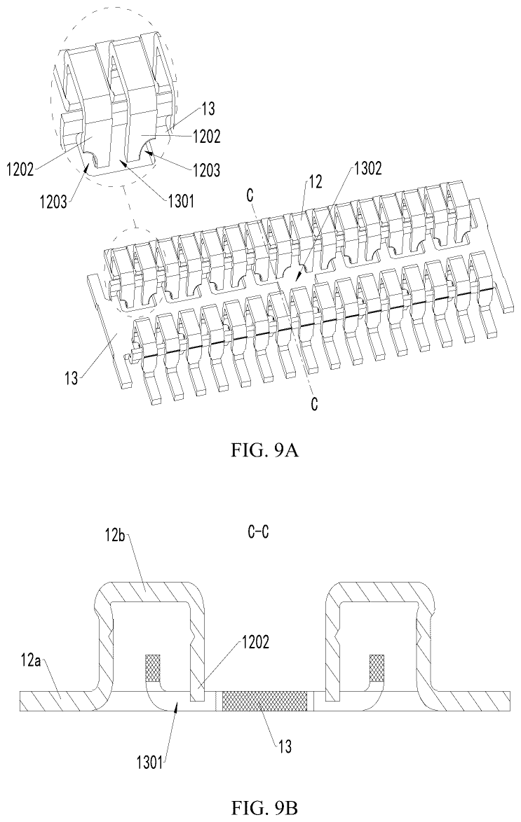

Refer to FIG. 8 to FIG. 9B. FIG. 8 is a diagram of a structure of the first connection terminal 12 in the connector plug 1 shown in FIG. 5A in some embodiments. FIG. 9A is a diagram of relative positions of the first connection terminal 12 and the reinforcing member 13 in the connector plug 1 shown in FIG. 5A in some embodiments. FIG. 9B is a diagram of a structure of the first connection terminal 12 and the reinforcing member 13 shown in FIG. 9A that are cut along a line C-C in some embodiments.

In some embodiments, the first connection terminal 12 may include a first part 12a and a second part 12b. The first part 12a of the first connection terminal 12 is connected to one end of the second part 12b of the first connection terminal 12. The second part 12b of the first connection terminal 12 may be of a U-shaped structure, and an opening of the U-shaped structure of the second part 12b of the first connection terminal 12 faces the reinforcing member 13. The first connection terminal 12 may include a first end 1201 and a second end 1202 that are arranged opposite to each other. The first end 1201 of the first connection terminal 12 is located at an end, away from the second part 12b of the first connection terminal 12, of the first part 12a of the first connection terminal 12. The second end 1202 of the first connection terminal 12 is located at an end, away from the first part 12a of the first connection terminal 12, of the second part 12b of the first connection terminal 12.

In this embodiment, the opening of the U-shaped structure of the second part 12b of the first connection terminal 12 faces the reinforcing member 13, so that the first connection terminal 12 is designed as a reverse terminal compared with a first connection terminal 12 in the conventional technology. This can avoid interference between the second part 12b of the first connection terminal 12 and the reinforcing member 13 in a thickness direction of the connector plug 1, to facilitate a thinning design of the connector plug 1.

A dashed line in FIG. 8 indicates a boundary between the first part 12a and the second part 12b of the first connection terminal 12. It can be understood that, in some other embodiments, a boundary between the first part 12a and the second part 12b of the first connection terminal 12 may alternatively be at another position.

For example, the first connection terminal 12 may not be in contact with the reinforcing member 13. One accommodation hole 1301 of the reinforcing member 13 may accommodate at least a part of second ends 1202 of at least two first connection terminals 12.

In this embodiment, the accommodation hole 1301 of the reinforcing member 13 is designed to be large, so that one accommodation hole 1301 can accommodate at least a part of second ends 1202 of at least two first connection terminals 12. This helps reduce a quantity of accommodation holes 1301 provided on the reinforcing member 13, to increase a width of a part of the reinforcing member 13 between two adjacent accommodation holes 1301, and improve structural strength of the part of the reinforcing member 13 between the two adjacent accommodation holes 1301. This helps improve overall structural strength of the reinforcing member 13.

At least two first connection terminals 12 that are partially accommodated in one accommodation hole 1301 may be arranged in the length direction of the reinforcing member 13. In the length direction of the reinforcing member 13, a side, close to an inner wall of the accommodation hole 1301, of the second end 1202 of the first connection terminal 12 is provided with a clearance groove 1203.

In this embodiment, the clearance groove 1203 is provided to increase a creepage distance between the second end 1202 of the first connection terminal 12 and the reinforcing member 13, to increase a safety spacing between the first connection terminal 12 and the reinforcing member 13, and avoid a short circuit between the first connection terminal 12 and the reinforcing member 13. In addition, because one accommodation hole 1301 can accommodate at least two first connection terminals 12, only one clearance groove 1203 needs to be provided on a side, close to an inner wall of the reinforcing member 13, of the second end 1202 of the first connection terminal 12, without a need to provide clearance grooves 1203 on both sides of the second end 1202 of the first connection terminal 12. In this way, a dimension of the second end 1202 of the first connection terminal 12 in the length direction of the reinforcing member 13 can be designed to be larger, to reduce difficulty in preparing the first connection terminal 12. In addition, because only one clearance groove 1203 needs to be provided on the side, close to the inner wall of the reinforcing member 13, of the second end 1202 of the first connection terminal 12, a size of the clearance groove 1203 may be designed to be large, to further increase a creepage distance between the second end 1202 of the first connection terminal 12 and the reinforcing member 13, further increase a safety spacing between the first connection terminal 12 and the reinforcing member 13, and further avoid a short circuit between the first connection terminal 12 and the reinforcing member 13.

The embodiment of FIG. 9A shows an example in which one accommodation hole 1301 of the reinforcing member 13 accommodates a part of second ends 1202 of two first connection terminals 12, but does not constitute a limitation on a quantity of first connection terminals 12 correspondingly accommodated in one accommodation hole 1301.

In the embodiment of FIG. 9A, the interruption hole 1302 is in communication with four accommodation holes 1301. In this way, each group of accommodation holes 1301 include two accommodation holes 1301 that are in communication with each other and that accommodate second ends 1202 of four first connection terminals 12.

For example, the second part 12b of the first connection terminal 12 may have two inner side surfaces that are arranged opposite to each other, and a groove 1204 may be provided on each of the two inner side surfaces that are arranged opposite to each other.

Still refer to FIG. 7B and FIG. 9A. In some examples, the reinforcing member 13 may have at least one interruption hole 1302. The interruption hole 1302 is located between two adjacent accommodation holes 1301 and is in communication with at least two accommodation holes 1301, to reduce a risk of warpage and deformation of the reinforcing member 13 during oven processing.

One accommodation hole 1301 may accommodate at least a part of second ends 1202 of at least two first connection terminals 12. Therefore, the accommodation hole 1301 of the reinforcing member 13 may be designed to be large, to increase a width of a part of the reinforcing member 13 between two adjacent accommodation holes 1301. This helps improve overall structural strength of the reinforcing member 13. In some other embodiments, one accommodation hole 1301 of the reinforcing member 13 may alternatively accommodate at least a part of a second end 1202 of one first connection terminal 12.

In some other examples, one accommodation hole 1301 of the reinforcing member 13 may accommodate at least a part of second ends 1202 of at least two first connection terminals 12. Therefore, the accommodation hole 1301 of the reinforcing member 13 is designed to be large, to increase a width of a part of the reinforcing member 13 between two adjacent accommodation holes 1301. This helps improve overall structural strength of the reinforcing member 13.

The reinforcing member 13 may have at least one interruption hole 1302. The interruption hole 1302 is located between two adjacent accommodation holes 1301 and is in communication with at least two accommodation holes 1301, to reduce a risk of warpage and deformation of the reinforcing member 13 during oven processing. In some other embodiments, the reinforcing member 13 may alternatively not be provided with an interruption hole 1302. Correspondingly, in addition to metal, the reinforcing member 13 may alternatively be made of ceramic.

The interruption hole 1302 may have an orthographic projection 1302a on the reinforcing member 13 in the length direction (refer to a direction D1 in FIG. 7B) of the reinforcing member 13, and a ratio of a dimension (refer to W1 in FIG. 7B) of the orthographic projection 1302a in the width direction (refer to a direction D2 in FIG. 7B) of the reinforcing member 13 to a width (refer to W2 in FIG. 7B) of the reinforcing member 13 may be greater than or equal to 90%.

In this embodiment of this disclosure, that the reinforcing member 13 has the interruption hole 1302 and one accommodation hole 1301 can accommodate at least a part of second ends 1202 of at least two first connection terminals 12 is used as an example for description, and the reinforcing member 13 does not necessarily need to have both of the foregoing two features. In some other embodiments, the reinforcing member 13 may have only one of the foregoing two features.

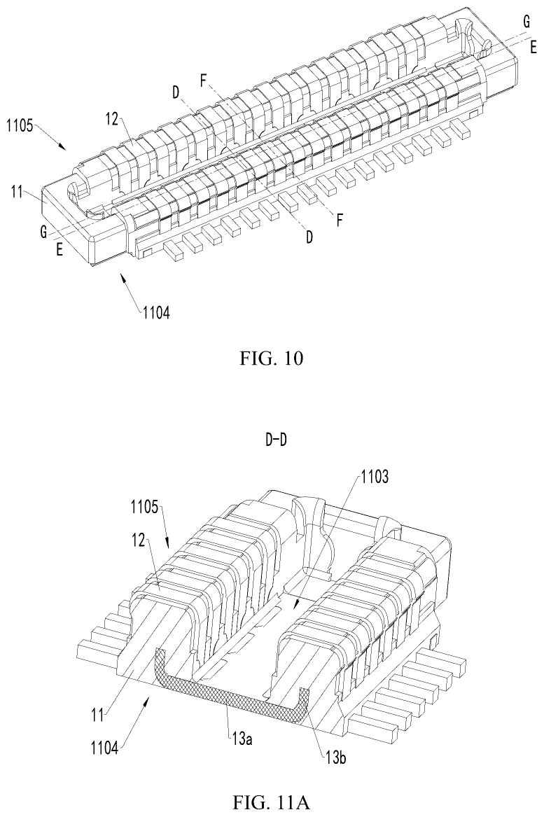

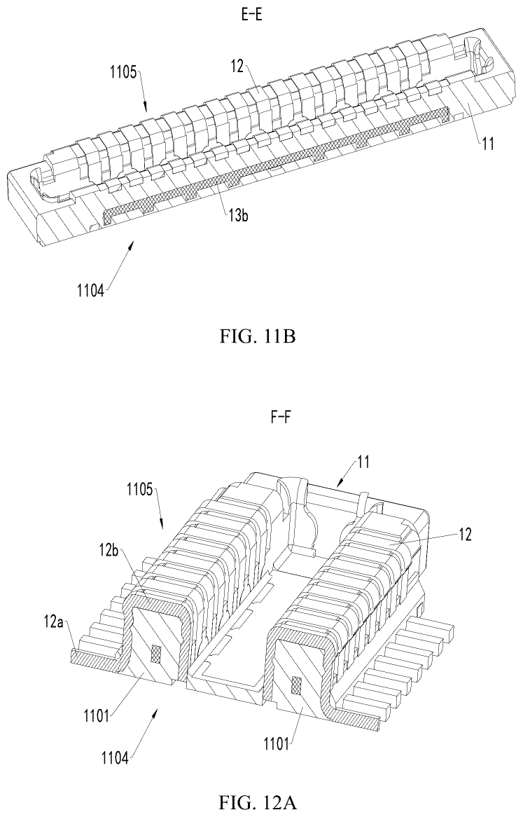

Refer to FIG. 10 to FIG. 11B. FIG. 10 is a diagram of a structure of the first connection terminal 12 and the reinforcing member 13 shown in FIG. 9A being mounted to the first body 11 in some embodiments. FIG. 11A is a diagram of a partial structure of the connector plug 1 shown in FIG. 10 that is cut along a line D-D in some embodiments. FIG. 11B is a diagram of a partial structure of the connector plug 1 shown in FIG. 10 that is cut along a line E-E in some embodiments.

In some embodiments, the first body 11 may be prepared through an injection molding process. Specifically, injection molding is performed by using an injection mold in fitting with the arrangement of the first connection terminal 12 and the reinforcing member 13 shown in FIG. 9A, to obtain the first body 11.

In this embodiment, the first body 11 is prepared through injection molding on the plug. This can improve strength of connections between the first body 11 and the first connection terminal 12 and between the first body 11 and the reinforcing member 13, to improve structural strength of the connector plug 1.

For example, the first body 11 may have a first side 1104 and a second side 1105 that are arranged facing away from each other. The first part 13a of the reinforcing member 13 may be mounted on the first side 1104 of the first body 11. Relative to the first part 13a of the reinforcing member 13, the second part 13b of the reinforcing member 13 may be bent in a direction of being embedded into the first body 11.

In this embodiment, relative to the first part 13a of the reinforcing member 13, the second part 13b of the reinforcing member 13 may be disposed to be bent in the direction of being embedded into the first body 11, to improve strength of a connection between the reinforcing member 13 and the first body 11, and further improve structural strength of the connector plug 1.

The reinforcing member 13 may cover at least a part of the fitting space 1103 that is located on the first side 1104 of the first body 11.

The first part 13a of the reinforcing member 13 may be embedded into a surface on the first side 1104 of the first body 11, to further improve strength of a connection between the reinforcing member 13 and the first body 11, and improve structural strength of the connector plug 1.

A surface, facing away from the second side 1105 of the first body 11, of the reinforcing member 13 may be flush with the surface on the first side 1104 of the first body 11, to improve flatness of the surface of the connector plug 1 on the first side 1104 of the first body 11.

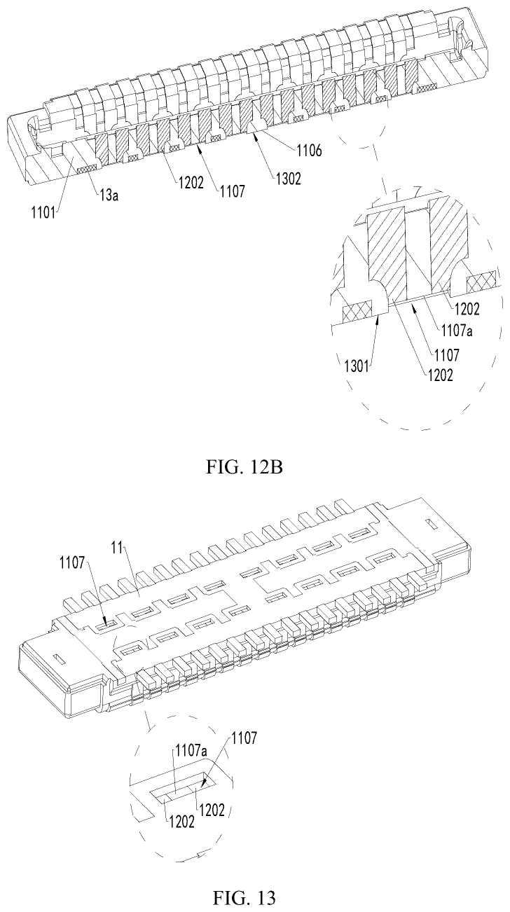

Refer to both FIG. 12A and FIG. 12B. FIG. 12A is a diagram of a partial structure of the connector plug 1 shown in FIG. 10 that is cut along a line F-F in some embodiments. FIG. 12B is a diagram of a partial structure of the connector plug 1 shown in FIG. 10 that is cut along a line G-G in some embodiments.

In some embodiments, the first connection terminal 12 may be sleeved on an outer surface on the second side 1105 of the first body 11, and is partially embedded into the first body 11. Specifically, the first connection terminal 12 may be sleeved on an outer surface of the cantilever 1101 that is located on the second side 1105 of the first body 11, and the first connection terminal 12 may be embedded into the first body 11 from the second side 1105 of the first body 11.

In this embodiment, the first connection terminal 12 is sleeved on the cantilever 1101, so that the U-shaped structure of the second part 12b of the first connection terminal 12 can match the cantilever 1101, to implement structural adaptation between the first connection terminal 12 and the cantilever 1101. This helps improve strength of a connection between the first connection terminal 12 and the first body 11. In addition, the first connection terminal 12 is partially embedded into the first body 11, to further improve strength of a connection between the first connection terminal 12 and the first body 11, and improve stability of mounting of the first connection terminal 12. This helps improve stability of the first connection terminal 12 during plugging/unplugging between the connector plug 1 and the connector receptacle 2.

For example, the first part 12a of the first connection terminal 12 extends out of the first body 11, so that the first end 1201 of the first connection terminal 12 can extend out of the first body 11. This enables the first end 1201 of the first connection terminal 12 to connect to an external circuit.

For example, a part of the first body 11 is embedded into the groove 1204 of the first connection terminal 12, to improve strength of a connection between the first body 11 and the second part 12b of the first connection terminal 12. The part of the first body 11 that is embedded into the groove 1204 can perform position limiting for the first connection terminal 12, to prevent displacement of the first connection terminal 12 on the first body 11.

A cantilever 1101 may be embedded into a joint between the first part 12a of the first connection terminal 12 and the second part 12b of the first connection terminal 12, and the first part 12a of the first connection terminal 12 extends in a direction away from the other cantilever 1101. In this embodiment, the cantilever 1101 is embedded into a bent part of the first connection terminal 12. This helps improve stability of the first connection terminal 12 and the first body 11, and a part of the first body 11 that surrounds the bent part of the first connection terminal 12 can perform position limiting for the first connection terminal 12, to prevent displacement of the first connection terminal 12 on the first body 11.

At least a part of the second end 1202 of the first connection terminal 12 is embedded into the first body 11. In this way, a part of the first body 11 that surrounds the second end 1202 of the first connection terminal 12 performs position limiting for the first connection terminal 12, to prevent displacement of the first connection terminal 12 on the first body 11.

Refer to FIG. 7A, FIG. 11B, and FIG. 12B. In some embodiments, a part of the accommodation hole 1301 is located in the first part 13a of the reinforcing member 13, and the other part of the accommodation hole 1301 is located in the second part 13b of the reinforcing member 13. In this way, the part of the first body 11 that is embedded into the accommodation hole 1301 can perform position limiting for both the first part 13a and the second part 13b of the reinforcing member 13, to increase a position-limiting range for the reinforcing member 13 in a thickness direction of the first body 11. This helps improve strength of a connection between the first body 11 and the reinforcing member 13, to improve structural strength of the connector plug 1.

In some embodiments, a part of the first body 11 may be embedded into the interruption hole 1302.

In this embodiment, a part of the first body 11 is embedded into the interruption hole 1302. In this way, the part of the first body 11 that is embedded into the interruption hole 1302 and the part of the first body 11 that is embedded into the accommodation hole 1301 jointly perform position limiting for the reinforcing member 13. This further improves a position-limiting capability of the first body 11 for the reinforcing member 13, further improves strength of a connection between the first body 11 and the reinforcing member 13, and helps improve structural strength of the connector plug 1.

For example, the first body 11 may further include a connection arm 1106. The connection arm 1106 may be connected between the two cantilevers 1101, and the connection arm 1106 may be embedded into the interruption hole 1302. In this embodiment, the connection arm 1106 embedded into the interruption hole 1302 may be integrated with the two cantilevers 1101, to improve a position-limiting capability of the connection arm 1106 for the reinforcing member 13, and further improve strength of a connection between the reinforcing member 13 and the first body 11.

Refer to FIG. 9B, FIG. 12B, and FIG. 13. FIG. 13 is a diagram of a partial structure of the connector plug 1 shown in FIG. 10 from another perspective.

In some embodiments, at least a part of the second end 1202 of the first connection terminal 12 may be located in the accommodation hole 1301.

In this embodiment, because a part of the first body 11 is embedded into the accommodation hole 1301, the part of the first body 11 that is embedded into the accommodation hole 1301 can be disposed around the second end 1202 of the first connection terminal 12. In this way, an inner wall of the accommodation hole 1301 and the part of the first body 11 that is embedded into the accommodation hole 1301 jointly perform position limiting for the second end 1202 of the first connection terminal 12. This further improves stability of mounting of the first connection terminal 12 in the connector plug 1, and helps avoid displacement of the first connection terminal 12 during plugging/unplugging between the connector plug 1 and the connector receptacle 2.

For example, the connector plug 1 may further include an insulation layer (not shown in the figure). The insulation layer covers at least a partial surface of the reinforcing member 13, to prevent the first connection terminal 12 from deviating due to flow of an injection molding material and getting in contact with the reinforcing member 13 during formation of the first body 11 through injection molding. The insulation layer prevents an open circuit caused by contact between the first connection terminal 12 and the reinforcing member 13. In addition, the insulation layer may further prevent a short circuit in the following case: A process error of the first connection terminal 12 causes an excessively small creepage distance between the first connection terminal 12 and the reinforcing member 13; or a process defect, for example, a burr on an outer surface of the first connection terminal 12, causes contact between the first connection terminal 12 and the reinforcing member 13.

The insulation layer may cover an area, close to the first connection terminal 12, of the reinforcing member 13. For example, the insulation layer may cover an inner side wall of the accommodation hole 1301, and/or the insulation layer may cover an area, directly facing the first connection terminal 12, of the reinforcing member 13.

The insulation layer may alternatively cover the surfaces of the reinforcing member 13, to further improve insulation performance of the reinforcing member 13 and reduce a risk of a short circuit.

The insulation layer may be made of an insulation material such as insulation spray paint or insulation plastic. A thickness range of the insulation layer may be within a range of 0.08 mm to 0.12 mm, so that the insulation layer can provide good insulation effect for the reinforcing member 13, without excessively increasing a thickness of the reinforcing member 13. For example, a thickness of the insulation layer may be but is not limited to 0.08 mm, 0.09 mm, 0.10 mm, 0.11 mm, 0.12 mm, or another value ranging from 0.08 mm to 0.12 mm.

For example, the part of the first body 11 that is embedded into the accommodation hole 1301 may have a positioning groove 1107. An opening of the positioning groove 1107 may face away from the first connection terminal 12. The second end 1202 of the first connection terminal 12 may be embedded into the first body 11 and exposed in the positioning groove 1107.

In this embodiment, during formation of the first body 11 through injection molding, a fastening structure may be designed, by using an injection mold, to abut against the end face of the second end 1202 of the first connection terminal 12, to ensure stability of the first connection terminal 12 during formation of the first body 11 through injection molding. This prevents the first connection terminal 12 from moving with flow of an injection molding material, to prevent contact or an excessively small creepage distance between the first connection terminal 12 and the reinforcing member 13. After the first body 11 is formed through injection molding, the positioning groove 1107 is formed at a position at which the fastening structure abuts against the end face of the second end 1202 of the first connection terminal 12.

The end face of the first connection terminal 12 that is exposed in the positioning groove 1107 may be flush with a bottom wall 1107a of the positioning groove 1107, so that the second end 1202 of the first connection terminal 12 can be better wrapped by the first body 11. This helps improve strength of a connection between the first connection terminal 12 and the first body 11.

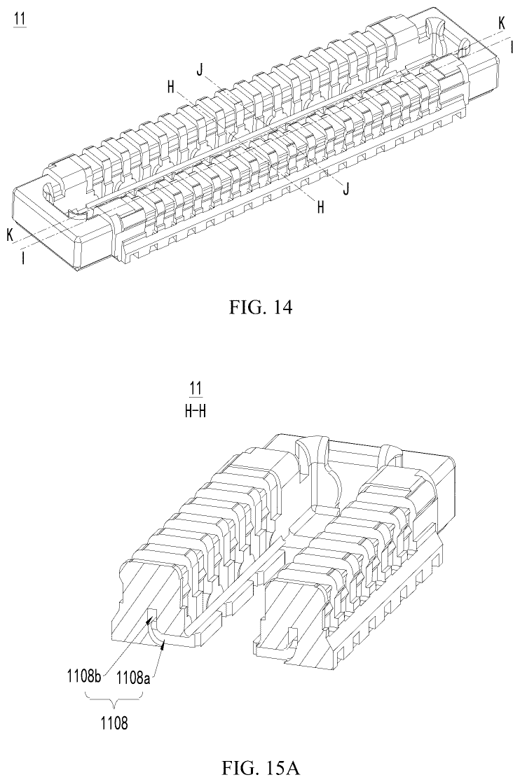

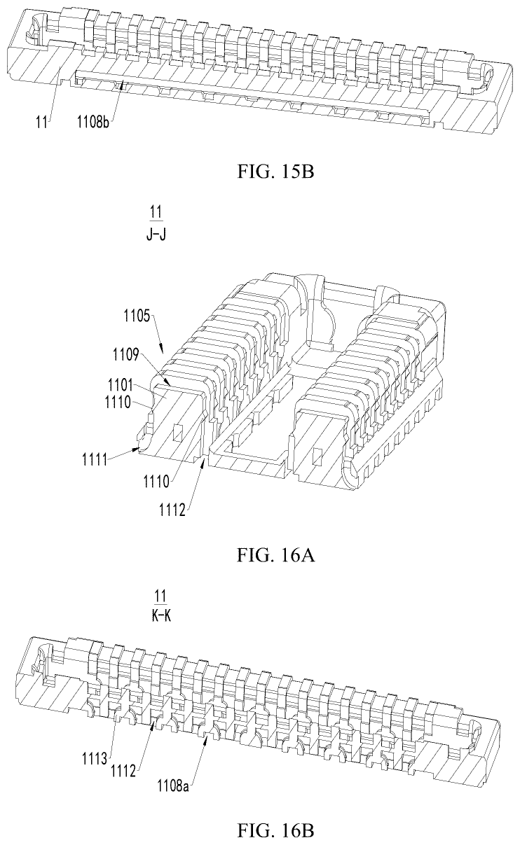

Refer to FIG. 11A, FIG. 14, and FIG. 15A. FIG. 14 is a diagram of a structure of the first body 11 in the partial structure of the connector plug 1 shown in FIG. 10 in some embodiments. FIG. 15A is a diagram of a structure of the first body 11 shown in FIG. 14 that is cut along a line H-H in some embodiments.

In some embodiments, the first body 11 may have a first mounting slot 1108, and the first mounting slot 1108 may be designed in a shape similar to that of the reinforcing member 13.

In this embodiment, because the first body 11 is formed through injection molding based on the reinforcing member 13, the first connection terminal 12, and the injection mold, a shape of the first mounting slot 1108 can be the same as that of the reinforcing member 13, to make connection between the first body 11 and the reinforcing member 13 stable. This helps improve structural strength of the connector plug 1.

For example, the first mounting slot 1108 may include a first part 1108a and a second part 1108b. The first part 1108a of the first mounting slot 1108 is recessed on the surface on the first side 1104 of the first body 11, and the second part 1108b of the first mounting slot 1108 may be recessed on a bottom wall of the first part 1108a of the first mounting slot 1108. The first part 1108a of the first mounting slot 1108 may fit with the first part 13a of the reinforcing member 13, and the second part 1108b of the first mounting slot 1108 may fit with the second part 13b of the reinforcing member 13.

Refer to both FIG. 11B and FIG. 15B. FIG. 15B is a diagram of a structure of the first body 11 shown in FIG. 14 that is cut along a line I-I in some embodiments.

In some embodiments, the second part 1108b of the first mounting slot 1108 may extend inside the first body 11 in a length direction of the first body 11, so that the second part 1108b of the first mounting slot 1108 can have a sufficient length to fit with the second part 13b of the reinforcing member 13. This helps improve strength of a connection between the first body 11 and the reinforcing member 13.

Refer to both FIG. 12A and FIG. 16A. FIG. 16A is a diagram of a structure of the first body 11 shown in FIG. 14 that is cut along a line J-J in some embodiments.

In some embodiments, the first body 11 may have a second mounting slot 1109, and the second mounting slot 1109 is recessed on an outer surface of the cantilever 1101 on the second side 1105 of the first body 11. In this embodiment, the second mounting slot 1109 is of a U-shaped structure, to improve stability of the second part 12b of the first connection terminal 12 that is mounted in the second mounting slot 1109, and improve stability of a connection between the first connection terminal 12 and the first body 11.

For example, bumps 1110 are provided on two bottom walls of the second mounting slot 1109 that are arranged facing away from each other. The bump 1110 is configured to be embedded into the groove 1204 of the first connection terminal 12, so that the bump 1110 performs position limiting for the first connection terminal 12. This helps improve stability of a connection between the first connection terminal 12 and the first body 11.

For example, the first body 11 may have a first mounting hole 1111 and a second mounting hole 1112. The first mounting hole 1111 and the second mounting hole 1112 are provided on two sides of the cantilever 1101 that face away from each other. In addition, the first mounting hole 1111 and the second mounting hole 1112 connect to two ends of the second mounting slot 1109, and both are in communication with the second mounting slot 1109.

In this embodiment, the first mounting hole 1111 is provided, so that the first part 12a of the first connection terminal 12 can extend out of the first body 11 through the first mounting hole 1111. This performs position limiting for the first part 12a of the first connection terminal 12 during limiting. The second mounting hole 1112 is provided, so that the second part 12b of the first connection terminal 12 can extend into the second mounting hole 1112. This performs position limiting for the second part 12b of the first connection terminal 12 during mounting. Therefore, the first mounting hole 1111 and the second mounting hole 1112 can jointly perform position limiting for the first connection terminal 12 during mounting, to improve stability of a connection between the first connection terminal 12 and the first body 11.

Refer to both FIG. 12B and FIG. 16B. FIG. 16B is a diagram of a structure of the first body 11 shown in FIG. 14 that is cut along a line K-K in some embodiments.

In some embodiments, the first body 11 may further include an avoidance rib 1113, and the avoidance rib 1113 may be located between the second mounting hole 1112 and the first part 1108a of the first mounting slot 1108.

In this embodiment, the second end 1202 of the first connection terminal 12 is separated from the reinforcing member 13 by the avoidance rib 1113, to insulate the first connection terminal 12 from the reinforcing member 13, and prevent a short circuit between the first connection terminal 12 and the reinforcing member 13. This facilitates performance stability of the connector plug 1.

For example, the avoidance rib 1113 may partially protrude in a direction toward the second mounting hole 1112, so that the avoidance rib 1113 can be adjacent to and fit with the clearance groove 1203 of the first connection terminal 12, to improve matching between the avoidance rib 1113 and the first connection terminal 12. This improves position limiting effect of the first body 11 for the first connection terminal 12, and further improves structural strength of the connector plug 1.

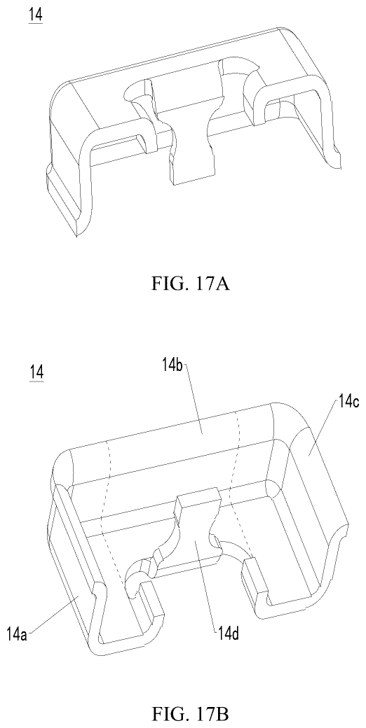

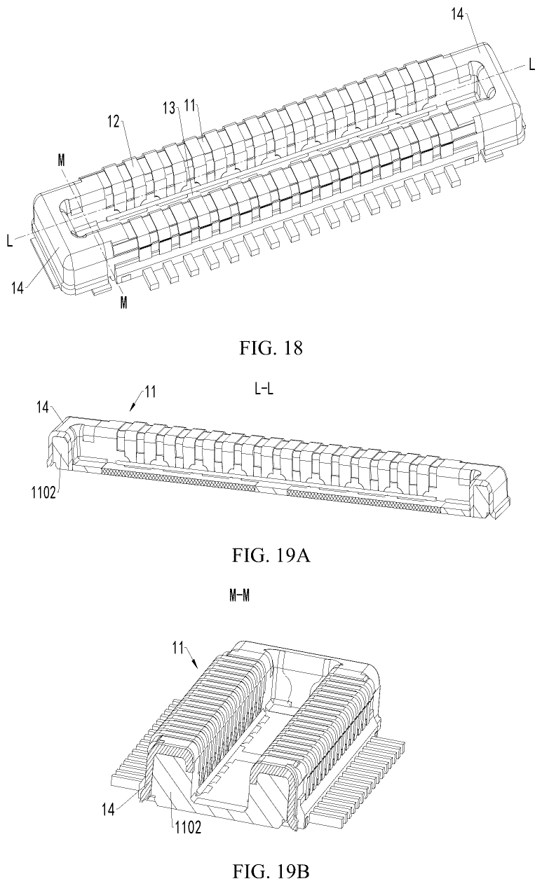

Refer to FIG. 17A to FIG. 18. FIG. 17A is a diagram of a structure of the first end hardware 14 in the connector plug 1 shown in FIG. 5A in some embodiments. FIG. 17B is a diagram of a structure of the first end hardware 14 shown in FIG. 17A from another perspective. FIG. 18 is a diagram of a structure of the first end hardware 14 shown in FIG. 17A being mounted to the first body 11 shown in FIG. 10 in some embodiments.

In some embodiments, the first end hardware 14 may be sleeved on the connection end 1102 of the first body 11.

In this embodiment, the first body 11 may be formed through injection molding by using an injection mold in fitting with the first end hardware 14, the first connection terminal 12, and the reinforcing member 13, to improve strength of a connection between the first body 11 and the first end hardware 14. In some other embodiments, the first end hardware 14 may be sleeved on the connection end 1102 after the first body 11 is formed through injection molding.

For example, the first end hardware 14 may include a first part 14a, a second part 14b, and a third part 14c. The first part 14a of the first end hardware 14 and the third part 14c of the first end hardware 14 are connected to two opposite ends of the second part 14b of the first end hardware 14, and the first part 14a of the first end hardware 14 and the third part 14c of the first end hardware 14 protrude toward a same side of the second part 14b of the first end hardware 14.

In FIG. 17B, division of the first part 14a, the second part 14b, and the third part 14c of the first end hardware 14 is indicated by dashed lines. It can be understood that division of the first part 14a, the second part 14b, and the third part 14c of the first end hardware 14 may alternatively be performed at other positions.

In this embodiment, the first part 14a, the second part 14b, and the third part 14c of the first end hardware 14 are arranged in an enclosed manner to form a concave structure. This helps improve strength of a connection between the first end hardware 14 and the first body 11.

The first part 14a of the first end hardware 14, the second part 14b of the first end hardware 14, and the third part 14c of the first end hardware 14 are continuously connected.

In this embodiment, the first end hardware 14 may undergo a metal drawing process, so that the parts of the first end hardware 14 are continuous without interruption. This can improve continuity of joints between the first part 14a, the second part 14b, and the third part 14c of the first end hardware 14, and can also improve straightness of a straight-line structural area of the first end hardware 14, to improve structural strength and a guiding capability of the first end hardware 14.

The first end hardware 14 may further include a fourth part. The fourth part 14d of the first end hardware 14 is connected to one end of the second part 14b of the first end hardware 14, and is located between the first part 14a of the first end hardware 14 and the third part 14c of the first end hardware 14. In this embodiment, the second part 14b and the fourth part of the first end hardware 14 can clamp the connection end 1102 of the first body 11, to improve strength of a connection between the first end hardware 14 and the first body 11.

The first end hardware 14 may be made of metal such as iron, steel, or alloy steel, but is not limited thereto.

Refer to 17B, FIG. 19A, and FIG. 19B. FIG. 19A is a diagram of a partial structure of the connector plug 1 shown in FIG. 18 that is cut along a line L-L in some embodiments. FIG. 19B is a diagram of a partial structure of the connector plug 1 shown in FIG. 18 that is cut along a line M-M in some embodiments.

In some embodiments, the first part 14a, the second part 14b, and the third part 14c of the first end hardware 14 may be of an L-shaped structure, to improve strength of connections between the first end hardware 14 and the connection end 1102.

Specifically, the second part 14b of the first end hardware 14 may be attached to a top side surface of a connection end 1102 and a side surface, facing away from the other connection end 1102, of the connection end 1102. In addition, the fourth part 14d of the first end hardware 14 and the first end hardware 14 are adjacent to each other to form a concave structure, so that a part of the connection end 1102 snaps into a notch of the concave structure. This improves strength of a connection between the first end hardware 14 and the first body 11.

Specifically, the first part 14a of the first end hardware 14 and the third part 14c of the first end hardware 14 are arranged opposite to each other, and the first part 14a of the first end hardware 14 and the third part 14c of the first end hardware 14 are attached to the top side surface of the connection end 1102 and the two side surfaces of the connection end 1102 that are arranged facing away from each other, so that the first end hardware 14 is closely attached to the connection end 1102. This improves strength of a connection between the first end hardware 14 and the first body 11.

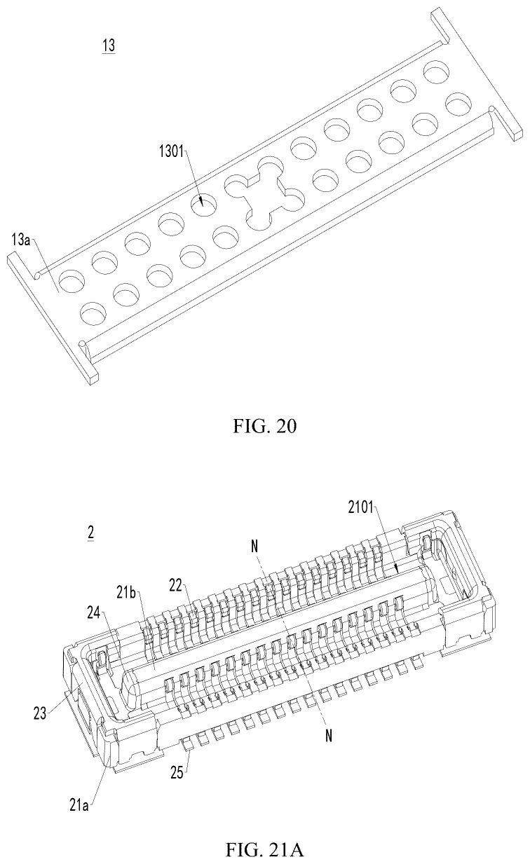

Refer to both FIG. 7A and FIG. 20. FIG. 20 is a diagram of a structure of the reinforcing member 13 in the connector plug 1 shown in FIG. 5A in still some other embodiments. The reinforcing member 13 shown in FIG. 20 may include most features of the reinforcing member 13 shown in FIG. 7A, and features of the reinforcing member 13 shown in FIG. 20 that are the same as those of the reinforcing member 13 shown in FIG. 7A are not described in detail again.

In some embodiments, the accommodation holes 1301 may be located in the first part 13a of the reinforcing member 13. In this embodiment, the accommodation holes 1301 are located in the first part 13a of the reinforcing member 13. This helps reduce difficulty in arranging the accommodation holes 1301.

A shape of the accommodation hole 1301 may be but is not limited to a circular shape, a square shape, a prismatic shape, or the like. In this embodiment, when the accommodation hole 1301 is in a circular shape, a width of a part of the reinforcing member 13 between two adjacent accommodation holes 1301 can be increased. Specifically, when the accommodation hole 1301 accommodates the first connection terminal 12, the first connection terminal 12 may be disposed on a diameter of the accommodation hole 1301 in the length direction of the reinforcing member 13. In this way, when a minimum spacing between two adjacent connection terminals meets a requirement for a creepage distance, a distance between other parts of the two adjacent connection terminals is increased, so that a width of a part of the reinforcing member 13 between two adjacent accommodation holes 1301 is increased, to improve structural strength of the reinforcing member 13.

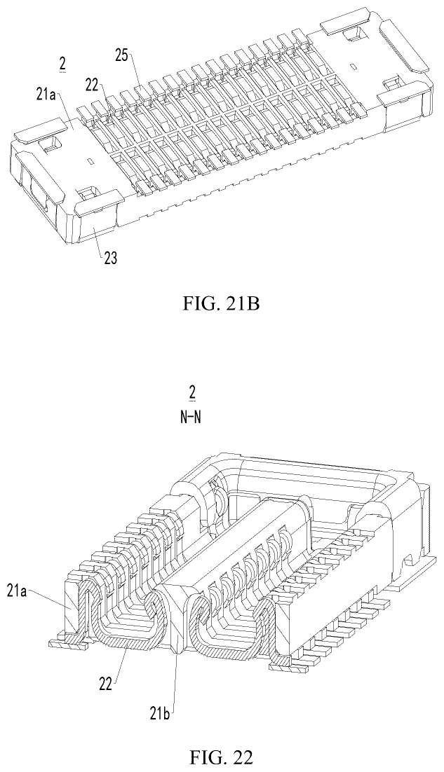

Refer to FIG. 21A to FIG. 22. FIG. 21A is a diagram of a structure of the connector receptacle 2 in the connector 10 shown in FIG. 3A in some embodiments. FIG. 21B is a diagram of a structure of the connector receptacle 2 shown in FIG. 21A from another perspective. FIG. 22 is a diagram of a structure of the connector receptacle 2 shown in FIG. 21A that is cut along a line N-N in some embodiments.

In some embodiments, the second connection terminal 22 may be located in the accommodation cavity 2101, and the second connection terminal 22 may be mounted between the first part 21a of the second body 21 and the second part 21b of the second body 21.

In this embodiment, the first part 21a of the second body 21 and the second part 21b of the second body 21 jointly perform position limiting for the second connection terminal 22 during mounting. This helps improve stability of mounting of the second connection terminal 22.

For example, the plurality of second connection terminals 22 may include two groups of terminals, and each group of terminals are arranged at spacings in a length direction of the second body 21. The two groups of terminals are arranged at spacings in a width direction of the second body 21, and are respectively located on two sides, facing away from each other, of the second part 21b of the second body 21.

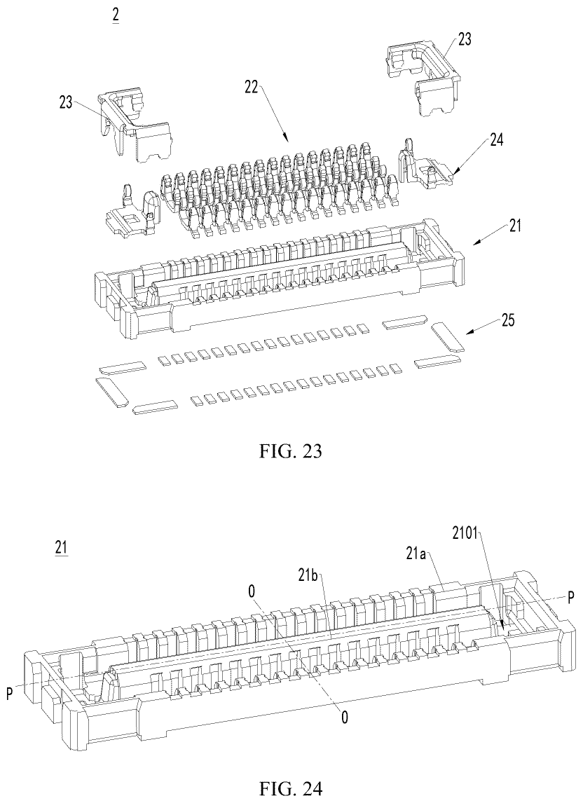

Refer to both FIG. 21A and FIG. 23. FIG. 23 is a schematic exploded view of a partial structure of the connector receptacle 2 shown in FIG. 21A in some embodiments.

In some embodiments, the connector receptacle 2 may further include a second end hardware 23, a middle island hardware 24, and a second pad 25.

For example, two second end hardwares 23 are mounted to two ends of the second body 21 in the length direction, and the second end hardware 23 is mounted to the first part 21a of the second body 21, to improve structural strength of the second body 21.

For example, two middle island hardwares 24 are disposed at the two ends of the second body 21 in the length direction, and the middle island hardware 24 is disposed between the first part 21a and the second part 21b of the second body 21, to improve structural strength of the second body 21.

For example, a plurality of second pads 25 are disposed in correspondence with the second connection terminals 22, and are configured to connect the second connection terminals 22 to an external circuit.

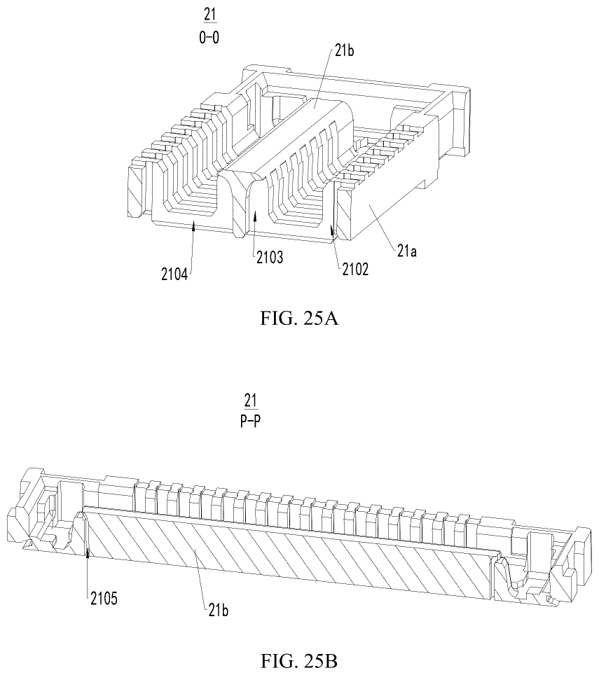

Refer to FIG. 24 to FIG. 25B. FIG. 24 is a diagram of a structure of the second body 21 in the connector receptacle 2 shown in FIG. 21A in some embodiments. FIG. 25A is a diagram of a structure of the second body 21 shown in FIG. 24 that is cut along a line O-O in some embodiments. FIG. 25B is a diagram of a structure of the second body 21 shown in FIG. 24 that is cut along a line P-P in some embodiments.

In some embodiments, the first part 21a of the second body 21 may have a third mounting slot 2102, and the third mounting slot 2102 is recessed on a surface, facing the second part 21b of the second body 21, of the first part 21a of the second body 21. The second part 21b of the second body 21 may have a limiting slot 2103, and the limiting slot 2103 is recessed on a surface, facing the first part 21a of the second body 21, of the second part 21b of the second body 21. The third mounting slot 2102 and the limiting slot 2103 may directly face each other. There are a plurality of third mounting slots 2102 and a plurality of limiting slots 2103, and both a quantity of third mounting slots 2102 and a quantity of limiting slots 2103 are equal to a quantity of second connection terminals 22.

In some embodiments, the second body 21 may have a third mounting hole 2104, and the third mounting hole 2104 passes through the bottom wall of the accommodation cavity 2101 in a thickness direction of the second body 21. The third mounting hole 2104 is located between the third mounting slot 2102 and the limiting slot 2103, and is in communication with the third mounting slot 2102 and the limiting slot 2103.

In some embodiments, the second part 21b of the second body 21 may have a fourth mounting hole 2105, and the fourth mounting hole 2105 passes through the second part 21b of the second body 21 in the thickness direction of the second body 21. Two fourth mounting holes 2105 are located at two ends of the second part 21b of the second body 21 in a length direction.

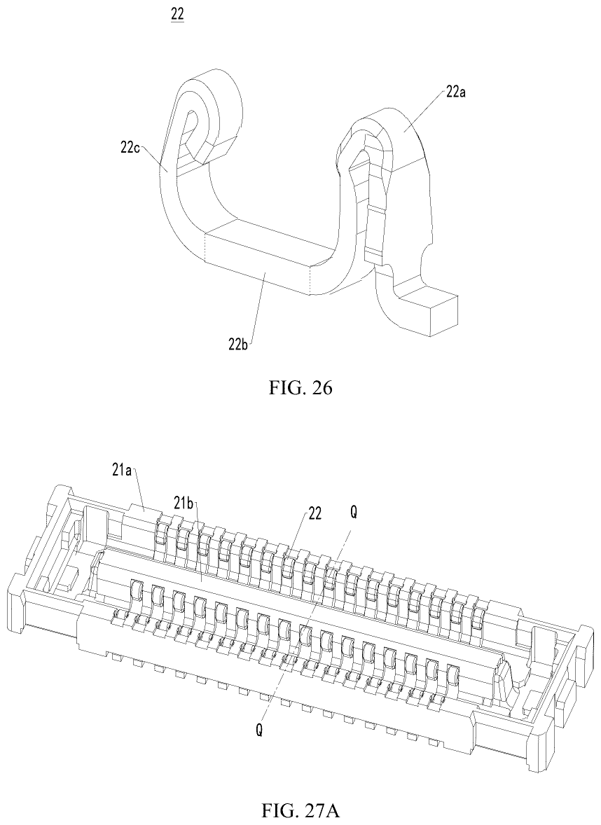

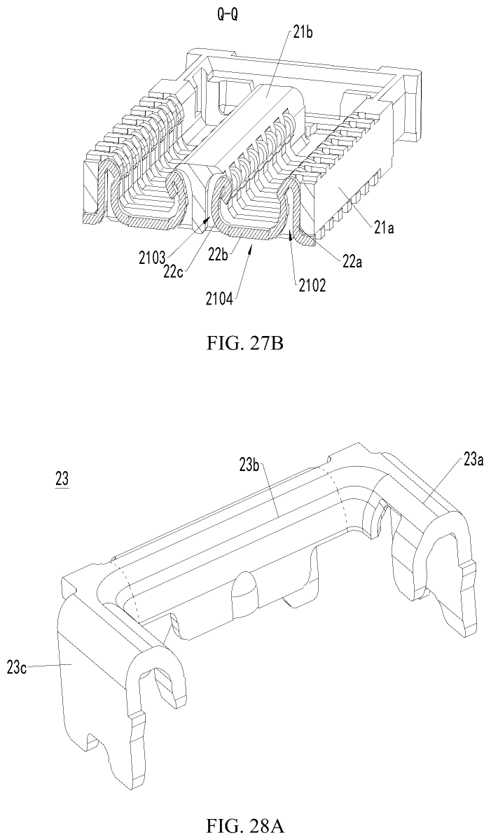

Refer to FIG. 26 to FIG. 27B. FIG. 26 is a diagram of a structure of the second connection terminal 22 in the connector receptacle 2 shown in FIG. 21A in some embodiments. FIG. 27A is a diagram of a structure of the second connection terminal 22 shown in FIG. 26 being mounted to the second body 21 shown in FIG. 24 in some embodiments. FIG. 27B is a diagram of a partial structure of the connector receptacle 2 shown in FIG. 27A that is cut along a line Q-Q in some embodiments.

In some embodiments, the second connection terminal 22 may include a first part 22a, a second part 22b, and a third part 22c that are sequentially connected. The first part 22a of the second connection terminal 22 is at least partially embedded into the first part 21a of the second body 21. The second part 22b of the second connection terminal 22 is mounted to the bottom wall of the accommodation cavity 2101. The third part 22c of the second connection terminal 22 is at least partially accommodated in the limiting slot 2103. Specifically, the first part 22a of the second connection terminal 22 is mounted in the third mounting slot 2102, and the second part 22b of the second connection terminal 22 is mounted in the third mounting hole 2104.

In this embodiment, a bottom wall of the third mounting slot 2102 and a bottom wall of the limiting slot 2103 can perform position limiting for the second connection terminal 22, so that the first part 21a of the second body 21 and the second part 21b of the second body 21 perform position limiting for the second connection terminal 22 during mounting. This helps improve stability of mounting of the second connection terminal 22.

For example, the bottom wall of the limiting slot 2103 may be spaced away from the third part 22c of the second connection terminal 22, and the third part 22c of the second connection terminal 22 is configured to move away from or close to the first part 22a of the second connection terminal 22 after being subject to a force.

For example, the first part 22a of the second connection terminal 22 is of a convex structure. Specifically, an opening of the first part 22a of the second connection terminal 22 faces the bottom wall of the accommodation cavity 2101, one end of the first part 22a of the second connection terminal 22 is connected to the second part 22b of the second connection terminal 22, and the other end of the first part 22a of the second connection terminal 22 is bent to a bottom side of the first part 21a of the second body 21. In this way, the first part 22a of the second connection terminal 22 can snap-fit with the first part 21a of the second body 21, to improve stability of mounting of the second connection terminal 22.

In FIG. 26 and FIG. 27B, division of the first part 22a, the second part 22b, and the third part 22c of the second connection terminal 22 is indicated by dashed lines. It can be understood that, in some other embodiments, division of the first part 22a, the second part 22b, and the third part 22c of the second connection terminal 22 may alternatively be performed at other positions.

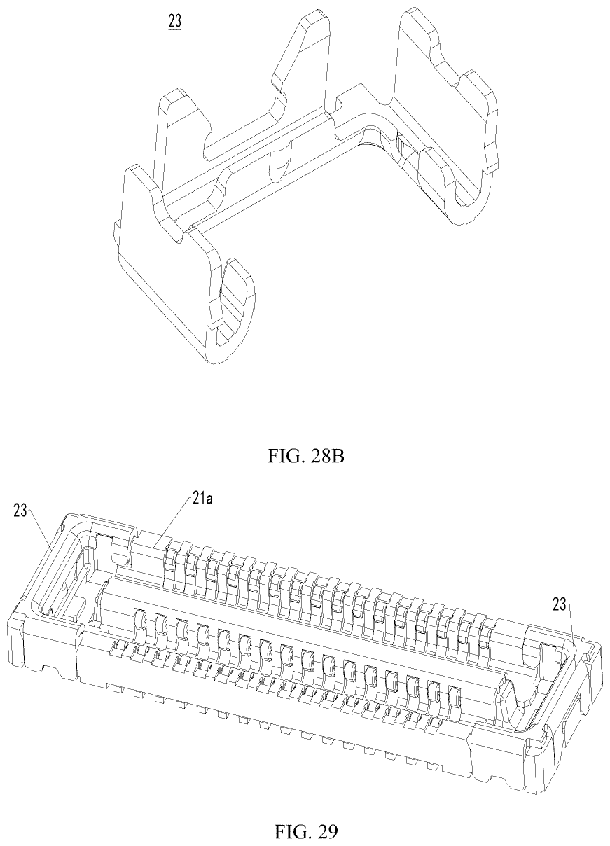

Refer to FIG. 28A to FIG. 29. FIG. 28A is a diagram of a structure of the second end hardware 23 in the connector receptacle 2 shown in FIG. 21A in some embodiments. FIG. 28B is a diagram of a structure of the second end hardware 23 shown in FIG. 28A from another perspective. FIG. 29 is a diagram of a structure of the second end hardware 23 shown in FIG. 28A being mounted to the second body 21 shown in FIG. 27A in some embodiments.

In some embodiments, two second end hardwares 23 may be mounted to two ends of the first part 21a of the second body 21 in a length direction. In this embodiment, the second end hardware 23 can improve structural strength of the second body 21, and the second end hardware 23 can further protect the two ends of the first part 21a of the second body 21.

For example, the second end hardware 23 may include a first part 23a, a second part 23b, and a third part 23c. The first part 23a of the second end hardware 23 and the third part 23c of the second end hardware 23 are connected to two opposite ends of the second part 23b of the second end hardware 23, and both protrude toward one side of the second part 23b of the second end hardware 23.

In this embodiment, the first part 23a, the second part 23b, and the third part 23c of the second end hardware 23 jointly form a concave structure. This helps improve stability of the second end hardware 23 mounted to the first part 21a of the second body 21, and helps improve structural strength of the connector receptacle 2.

The first part 23a of the second end hardware 23 may be of a concave structure, to improve stability of mounting between the first part 23a of the second end hardware 23 and the first part 21a of the second body 21.

The second part 23b of the second end hardware 23 may be of a concave structure, to improve stability of mounting between the second part 23b of the second end hardware 23 and the first part 21a of the second body 21.

The third part 23c of the second end hardware 23 may be of a concave structure, to improve stability of mounting between the third part 23c of the second end hardware 23 and the first part 21a of the second body 21.

The second end hardware 23 may undergo a metal drawing process, to improve smoothness of structures of the second end hardware 23, ensure continuity between different parts, and improve straightness of a straight-line structure. This helps improve structural stability and a guiding capability of the second end hardware 23.

In FIG. 28A, division of the first part 23a, the second part 23b, and the third part 23c of the second end hardware 23 is indicated by dashed lines. It can be understood that, in some other embodiments, division of the first part 23a, the second part 23b, and the third part 23c of the second end hardware 23 may alternatively be performed at other positions.

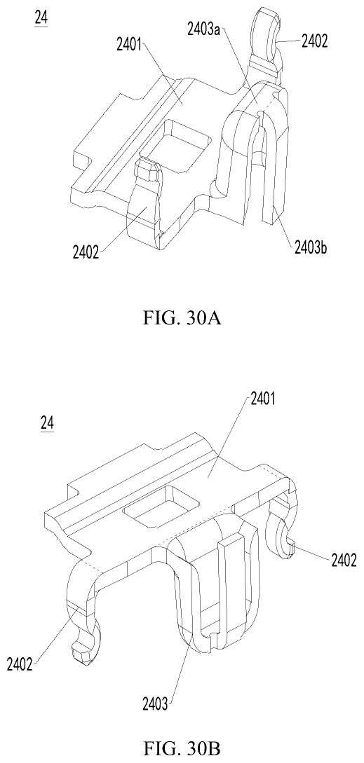

Refer to both FIG. 30A and FIG. 30B. FIG. 30A is a diagram of a structure of the middle island hardware 24 in the connector receptacle 2 shown in FIG. 21A in some embodiments. FIG. 30B is a diagram of a structure of the middle island hardware 24 shown in FIG. 30A from another perspective.

In some embodiments, the middle island hardware 24 may include a body 2401, two elastic arms 2402, and a snap-fit portion 2403. The two elastic arms 2402 are connected to two opposite sides of the body 2401. The snap-fit portion 2403 is connected to another side of the body 2401, and the snap-fit portion 2403 is located between the two elastic arms 2402.

In FIG. 30B, division of the body 2401, the two elastic arms 2402, and the snap-fit portion 2403 is indicated by dashed lines.

Both the elastic arm 2402 and the snap-fit portion 2403 are protrudingly disposed toward a same side of the body 2401.

The elastic arm 2402 may be in an S shape, so that the elastic arm 2402 can move close to or away from the other elastic arm 2402 after being subject to a force.

The snap-fit portion 2403 may include a first part 2403a and a second part 2403b. The first part 2403a of the snap-fit portion 2403 is connected to one side of the body 2401. The second part 2403b of the snap-fit portion 2403 is connected to an end, away from the body 2401, of the first part 2403a of the snap-fit portion 2403, and the second part 2403b of the snap-fit portion 2403 extends in a direction from the first part 2403a of the snap-fit portion 2403 to the body 2401. An end, away from the first part 2403a of the snap-fit portion 2403, of the second part 2403b of the snap-fit portion 2403 is spaced away from the body 2401, and is spaced away from the first part 2403a of the snap-fit portion 2403.

In FIG. 30A, division of the first part 2403a and the second part 2403b of the snap-fit portion 2403 is indicated by a dashed line. It can be understood that division of the first part 2403a and the second part 2403b of the snap-fit portion 2403 may alternatively be performed at another position.

The middle island hardware 24 may be formed by a metal drawing process, so that the middle island hardware 24 can be integrally formed. This improves smoothness of structures of the middle island hardware 24 and straightness of its linear structure, to help improve structural strength and a guiding capability of the middle island hardware 24.

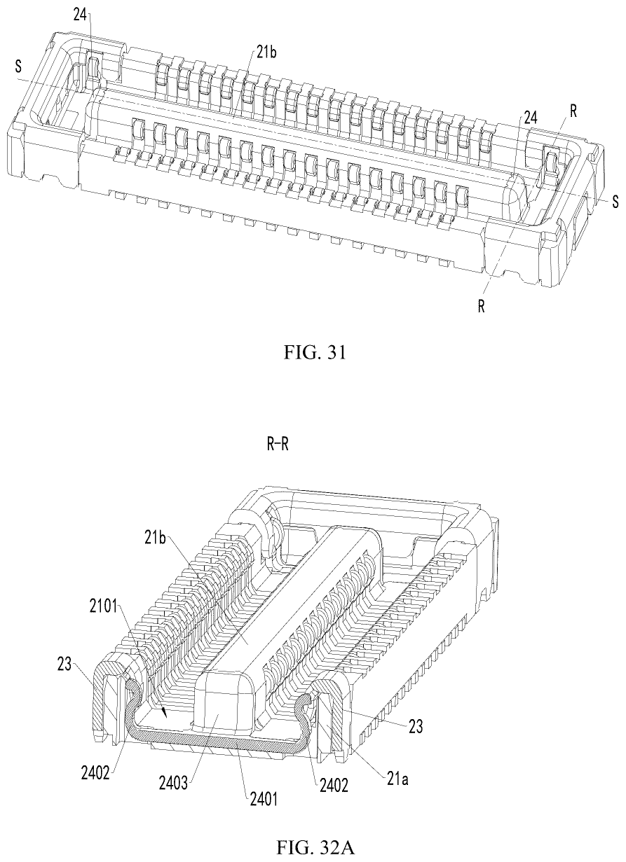

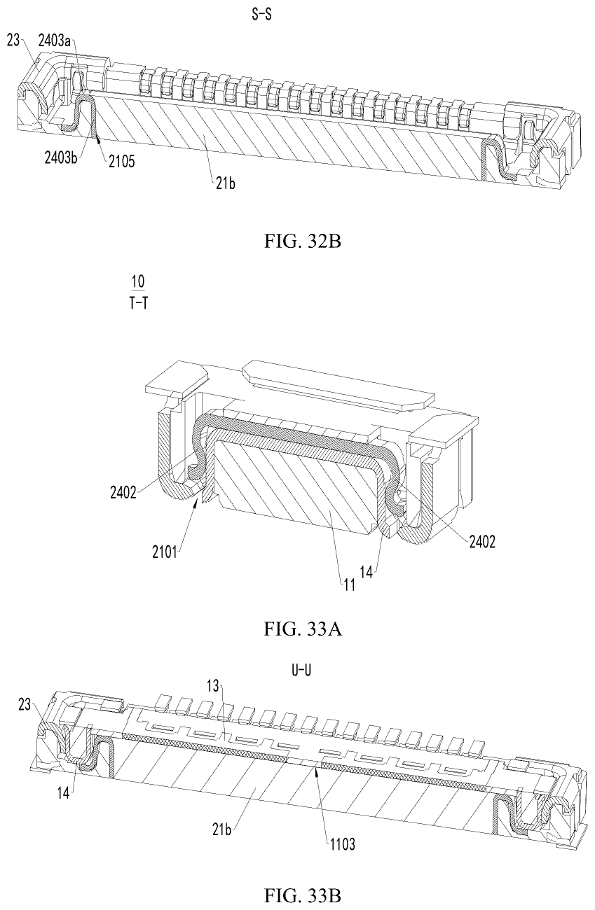

Refer to FIG. 31 to FIG. 32B. FIG. 31 is a diagram of a structure of the middle island hardware 24 shown in FIG. 30A being mounted to the second body 21 shown in FIG. 29 in some embodiments. FIG. 32A is a diagram of a partial structure of the connector receptacle 2 shown in FIG. 31 that is cut along a line R-R in some embodiments. FIG. 32B is a diagram of a partial structure of the connector receptacle 2 shown in FIG. 31 that is cut along a line S-S in some embodiments.

In some embodiments, the middle island hardware 24 may be mounted to two ends of the second part 21b of the second body 21. The body 2401 of the middle island hardware 24 may be mounted to the bottom wall of the accommodation cavity 2101. Specifically, the body 2401 may be mounted between an end of the second part 21b of the second body 21 in a length direction and the first part 21a of the second body 21. The snap-fit portion 2403 of the middle island hardware 24 may be mounted to an end of the second part 21b of the second body 21. The two elastic arms 2402 of the middle island hardware 24 are disposed close to the first part 21a of the second body 21.

The elastic arm 2402 is spaced away from the first part 21a of the second body 21, to provide movement space for deformation motion of the elastic arm 2402.

The first part 2403a of the snap-fit portion 2403 may be wrapped around an end of the second part 21b of the second body 21, and the second part 2403b of the snap-fit portion 2403 fits with the fourth mounting hole 2105, to improve strength of a connection between the snap-fit portion 2403 and the second part 21b of the second body 21, and further improve strength of a connection between the middle island hardware 24 and the second body 21.

In some embodiments, the second body 21 may be prepared through an injection molding process, so that the second body 21 can have good structural strength. Specifically, injection molding may be performed by using an injection mold in fitting with the second connection terminal 22, the second body 21, the second end hardware 23, and the middle island hardware 24, so that the prepared second body 21 can be well connected to the second connection terminal 22, the second end hardware 23, and the middle island hardware 24. This helps improve overall structural strength of the connector receptacle 2.

Refer to FIG. 3B, FIG. 33A, and FIG. 33B. FIG. 33A is a diagram of a structure of the connector 10 shown in FIG. 3A that is cut along a line T-T in some embodiments. FIG. 33B is a diagram of a structure of the connector 10 shown in FIG. 3A that is cut along a line U-U in some embodiments.

In some embodiments, the first body 11 of the connector plug 1 is plugged into the accommodation cavity 2101 of the second body 21 of the connector receptacle 2, and the first connection terminal 12 and the second connection terminal 22 are in conductive contact in a one-to-one correspondence manner.

For example, the second part 21b of the second body 21 of the connector receptacle 2 may be plugged into the fitting space 1103 of the connector plug 1, and abut against the reinforcing member 13.

In this embodiment, the fitting space 1103 of the connector plug 1 and the accommodation cavity 2101 of the connector receptacle 2 are designed, so that the connector plug 1 can snap-fit with the connector receptacle 2 during plugging. This not only can improve stability of a connection between the connector plug 1 and the connector receptacle 2, but also helps reduce an overall thickness of the connector 10 after the connector plug 1 is plugged into the connector receptacle 2, to facilitate a miniaturization design of the connector 10. In addition, the reinforcing member 13 is designed, to improve structural strength after the connector plug 1 is plugged into the connector receptacle 2, and further improve overall structural strength of the connector 10.

After the connector plug 1 is plugged into the connector receptacle 2, the connector plug 1 may not exceed a height of the connector receptacle 2. In other words, the connector plug 1 may be fully accommodated in the accommodation cavity 2101, to reduce an overall thickness of the connector 10.

A thickness of the connector receptacle 2 may be less than or equal to 0.5 mm, so that a thickness of the connector 10 can be less than or equal to 0.5 mm. This improves competitiveness of the connector 10 in terms of thinness.

A thickness of the second part 21b of the second body 21 in the connector receptacle 2 may be less than or equal to 0.44 mm. This helps reduce an overall thickness after the connector plug 1 is plugged into the connector receptacle 2, to facilitate a thinning design of the connector 10.

For example, the second part 12b of the first connection terminal 12 may snap-fit between the first part 22a of the second connection terminal 22 and the third part 22c of the second connection terminal 22. In a direction from the second part 21b of the second body 21 to the first part 21a of the second body 21, a minimum spacing between the third part 22c of the second connection terminal 22 and the first part 22a of the second connection terminal 22 may be less than a maximum dimension of the first connection terminal 12.

In this embodiment, the second part 12b of the first connection terminal 12 snap-fits between the first part 22a of the second connection terminal 22 and the third part 22c of the second connection terminal 22. This helps improve stability of a connection between the first connection terminal 12 and the second connection terminal 22, to facilitate stable transmission of an electrical signal. The minimum spacing between the third part 22c of the second connection terminal 22 and the first part 22a of the second connection terminal 22 may be less than the maximum dimension of the first connection terminal 12. In this way, when the connector plug 1 is being inserted into the connector receptacle 2, the first connection terminal 12 can expand the third part 22c of the second connection terminal 22, and after the second part 12b of the first connection terminal 12 is inserted, the first part 22a of the second connection terminal 22 and the third part 22c of the second connection terminal 22 can keep abutting against the second part 12b of the first connection terminal 12 based on a deformation recovery force, to clamp the second part 12b of the first connection terminal 12. This improves stability of a connection between the first connection terminal 12 and the second connection terminal 22.

In the connector 10, a deformation amount of the second connection terminal 22 may be greater than or equal to 0.1 mm, so that the second connection terminal 22 can have a sufficiently strong deformation recovery force, and the second connection terminal 22 can stably snap-fit with the first connection terminal 12.

For example, in a width direction of the first body 11, the first end hardware 14 in the connector plug 1 abuts against the two elastic arms 2402 of the middle island hardware 24 in the connector receptacle 2. A dimension of the first end hardware 14 in the width direction of the first body 11 is greater than a minimum spacing between the two elastic arms 2402.

In this embodiment, the elastic arms 2402 are disposed, so that the middle island hardware 24 can snap-fit with the first end hardware 14, to improve stability of a connection between the middle island hardware 24 and the first end hardware 14, and further improve stability of a connection between the connector plug 1 and the connector receptacle 2. The dimension of the first end hardware 14 in the width direction of the first body 11 is greater than the minimum spacing between the two elastic arms 2402. Therefore, in the connector 10, the elastic arms 2402 can keep abutting against the first end hardware 14 based on a deformation recovery force, to improve stability of snap-fit between the middle island hardware 24 and the first end hardware 14.

In the connector 10, a deformation amount of the elastic arms 2402 may be greater than or equal to 0.1 mm, so that the middle island hardware 24 can have a sufficiently strong deformation recovery force, and the middle island hardware 24 can stably snap-fit with the first end hardware 14.

For example, in the length direction of the first body 11, the first end hardware 14 abuts against the second end hardware 23.

In this embodiment, both the first end hardware 14 and the second end hardware 23 undergo a metal drawing process, so that effect of fitting between the first end hardware 14 and the second end hardware 23 is good, and stability of a connection between the connector plug 1 and the connector receptacle 2 is improved. In addition, the first end hardware 14 and the second end hardware 23 may participate in transmission of a current. Compared with an electrical connection between the first connection terminal 12 and the second connection terminal 22, abutting between the first end hardware 14 and the second end hardware 23 can implement transmission of a large current.

Embodiments of this disclosure or features in embodiments may be combined with each other if there is no conflict, and any combination of features in different embodiments also falls within the protection scope of this disclosure. That is, the plurality of embodiments described above may alternatively be combined according to an actual requirement.

All of the foregoing accompanying drawings are example drawings of this disclosure, and do not represent an actual size of a product. In addition, a size proportional relationship between components in the accompanying drawings is not intended to limit an actual product in this disclosure.

The foregoing descriptions are merely some embodiments and implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

1. A connector plug, comprising:
a first body;
a reinforcing member made of metal and embedded into the first body, wherein the reinforcing member has at least one interruption hole, the interruption hole has an orthographic projection on the reinforcing member in a length direction of the reinforcing member, and a ratio of a dimension of the orthographic projection in a width direction of the reinforcing member to a width of the reinforcing member is greater than or equal to 90%; and
a plurality of first connection terminals fastened to the first body and partially embedded into the first body.

2. The connector plug according to claim 1, wherein a part of the first body is embedded into the interruption hole.

3. The connector plug according to claim 1, wherein the reinforcing member has a plurality of accommodation holes, at least a part of the plurality of accommodation holes are arranged in the length direction of the reinforcing member, and the interruption hole is located between two adjacent accommodation holes and is in communication with at least two accommodation holes.

4. The connector plug according to claim 3, wherein a part of the first body is embedded into the accommodation hole.

5. The connector plug according to claim 3, wherein the plurality of accommodation holes comprise two groups of accommodation holes, each group of accommodation holes comprises a plurality of accommodation holes arranged in the length direction of the reinforcing member, the two groups of accommodation holes are arranged in the width direction of the reinforcing member, and the interruption hole is in communication with at least one accommodation hole in one group of accommodation holes and at least one accommodation hole in the other group of accommodation holes.

6. The connector plug according to claim 5, wherein the first body comprises two cantilevers and a connection arm, the connection arm is connected between the two cantilevers, one cantilever corresponds to one group of accommodation holes, a part of the cantilever is embedded into the corresponding group of accommodation holes 1301, and the connection arm is embedded into the interruption hole.

7. The connector plug according to claim 3, wherein the reinforcing member comprises a first part and a second part connected to each other, the first part of the reinforcing member is mounted on one side of the first body, and relative to the first part of the reinforcing member, the second part of the reinforcing member is bent in a direction of being embedded into the first body.

8. The connector plug according to claim 7, wherein a part of the accommodation hole is located in the first part of the reinforcing member.

9. The connector plug according to claim 8, wherein the other part of the accommodation hole is located in the second part of the reinforcing member.

10. The connector plug according to claim 1, wherein the connector plug further comprises an insulation layer, and the insulation layer covers at least a partial surface of the reinforcing member.

11. The connector plug according to claim 1, wherein the first body has a first side and a second side that are arranged facing away from each other, and the reinforcing member is embedded into the first side of the first body; and
the first connection terminal is sleeved on an outer surface on the second side of the first body, and is partially embedded into the first body.

12. The connector plug according to claim 11, wherein the first connection terminal comprises a first part and a second part connected to each other, and the first part of the first connection terminal extends out of the first body; and
the second part of the first connection terminal is of a U-shaped structure, is sleeved on the outer surface on the second side of the first body, and is partially embedded into the first body, and an opening of the U-shaped structure of the second part of the first connection terminal faces the reinforcing member.

13. The connector plug according to claim 1, wherein the first connection terminal comprises a first end and a second end that are arranged opposite to each other, and the first end of the first connection terminal extends out of the first body, to connect to an external circuit; and
at least a part of the second end of the first connection terminal is embedded into the first body.

14. The connector plug according to claim 13, wherein the reinforcing member has a plurality of accommodation holes, and one accommodation hole accommodates at least a part of second ends of at least two first connection terminals.

15. The connector plug according to claim 14, wherein at least two first connection terminals that are partially accommodated in one accommodation hole are arranged in the length direction of the reinforcing member; and
in the length direction of the reinforcing member, a side, close to an inner wall of the accommodation hole, of the second end of the first connection terminal is provided with a clearance groove.

16. The connector plug according to claim 14, wherein the part of the first body that is embedded into the accommodation hole has a positioning groove, and an opening of the positioning groove faces away from the first connection terminal; and
the second end of the first connection terminal is embedded into the first body and is exposed in the positioning groove, and an end face of the second end of the first connection terminal is flush with a bottom wall of the positioning groove.

17. The connector plug according to claim 1, wherein the first body comprises two cantilevers and two connection ends, and the two cantilevers are arranged opposite to each other;
the two connection ends are respectively connected to two opposite ends of the cantilever, and the connection end is connected between the two cantilevers; and
the two cantilevers and the two connection ends enclose fitting space, and the reinforcing member covers at least a part of one side of the fitting space.

18. The connector plug according to claim 17, wherein the connector plug further comprises a first end hardware, and the first end hardware is sleeved on the connection end; and
the first end hardware comprises a first part, a second part, and a third part, the first part of the first end hardware and the third part of the first end hardware are connected to two opposite ends of the second part of the first end hardware, the first part of the first end hardware and the third part of the first end hardware protrude toward a same side of the second part of the first end hardware, and the first part of the first end hardware, the second part of the first end hardware, and the third part of the first end hardware are continuously connected.

19. A connector, comprising:
a connector receptacle; and
a connector plug fitting with and electrically connected to the connector receptacle, wherein the connector plug comprises:
a first body;
a reinforcing member made of metal and embedded into the first body, wherein the reinforcing member has at least one interruption hole, the interruption hole has an orthographic projection on the reinforcing member in a length direction of the reinforcing member, and a ratio of a dimension of the orthographic projection in a width direction of the reinforcing member to a width of the reinforcing member is greater than or equal to 90%; and
a plurality of first connection terminals fastened to the first body and partially embedded into the first body.

20. An electronic device, comprising:
a first circuit board,
a second circuit board, and
a connector comprising a connector receptacle and a connector plug, wherein the connector plug fits with and is electrically connected to the connector receptacle,
wherein the connector plug includes:
a first body;
a reinforcing member made of metal and embedded into the first body, wherein the reinforcing member has at least one interruption hole, the interruption hole has an orthographic projection on the reinforcing member in a length direction of the reinforcing member, and a ratio of a dimension of the orthographic projection in a width direction of the reinforcing member to a width of the reinforcing member is greater than or equal to 90%; and
a plurality of first connection terminals fastened to the first body and partially embedded into the first body, and
wherein the connector plug is electrically connected to the first circuit board, and the connector receptacle is electrically connected to the second circuit board.
